(19) United States
(12) Patent Application Publication
(10) Pub. No.: US 2025/0368041 A1
(43) Pub. Date: Dec. 4, 2025

(54) ALERT DETECTION FOR VEHICLES

(71) Applicant: NIO Technology (Anhui) Co., LTD., Anhui (CN)

(72) Inventors: Hong Seok Kim, San Jose, CA (US); Emmanuel Saez, Saratoga, CA (US)

(73) Assignee: NIO Technology (Anhui) Co., LTD., Anhui (CN)

(21) Appl. No.: 18/678,632

(22) Filed: May 30, 2024

(51) Int. Cl. B60K 35/28; B60K 35/21; B60K 35/25

(52) U.S. Cl. CPC B60K 35/28; B60K 35/21; B60K 35/25; B60K 2360/741; B60K 2360/782

(57) ABSTRACT

The techniques described herein relate to alert detection for vehicles. An example system for alert detection in a vehicle comprises at least one processor to execute processor-executable instructions to cause the system to trigger a start of a time window in which an alert sound is expected to be perceived by an occupant of the vehicle as a warning to the occupant, generate a signal to output the alert sound in the vehicle and in the time window, receive audio data representing a plurality of acoustic sounds present in the vehicle and in the time window, determine, using the received audio data, a score representing a likelihood the occupant perceived the alert sound as the warning, and cause generation of an alert to gain attention of the occupant when the score indicates the occupant did not perceive the alert sound as the warning.

### FIELD

The techniques described herein relate generally to vehicles and, more particularly, to alert detection for vehicles.

### BACKGROUND

Vehicles are becoming increasingly complex with a growing number of interconnected systems. Some vehicle systems are designed for vehicle driving operation, such as a power steering system, while other systems are designed for improving driver and/or passenger safety. Some safety systems may generate audible alerts to the driver to indicate that increased attention by the driver is needed for a vehicle operation about to be performed. Ensuring that vehicle safety systems are functional and operate as intended provides enhanced safety for the vehicle's occupant(s).

### SUMMARY

In accordance with the disclosed subject matter, systems, apparatus, articles of manufacture, and methods are provided for alert detection for vehicles.

Some embodiments relate to a system for alert detection in a vehicle. The system comprises at least one storage medium storing processor-executable instructions, and at least one processor communicatively coupled to the at least one storage medium and, when the at least one processor executes the processor-executable instructions, causes the system to trigger a start of a time window in which an alert sound is expected to be perceived by an occupant of the vehicle as a warning to the occupant, generate a signal to output the alert sound in the vehicle and in the time window, receive audio data representing a plurality of acoustic sounds present in the vehicle and in the time window, determine, using the received audio data, a score representing a likelihood the occupant perceived the alert sound as the warning, and cause generation of an alert to gain attention of the occupant when the score indicates the occupant did not perceive the alert sound as the warning.

Some embodiments relate to a method for alert detection in a vehicle. The method comprises triggering a start of a time window in which an alert sound is expected to be perceived by an occupant of the vehicle as a warning to the occupant, generating a signal to output the alert sound in the vehicle and in the time window, receiving audio data representing a plurality of acoustic sounds present in the vehicle and in the time window, determining, using the received audio data, a score representing a likelihood the occupant perceived the alert sound as the warning, and generating an alert to gain attention of the occupant when the score indicates the occupant did not perceive the alert sound as the warning.

Some embodiments relate to a vehicle comprising at least one audio output device to output an alert sound, at least one audio sensor to receive a plurality of acoustic sounds present in the vehicle, an alert detection system, at least one storage medium storing processor-executable instructions, and at least one processor communicatively coupled to the at least one storage medium and, when the at least one processor executes the processor-executable instructions, causes the vehicle to trigger, by the alert detection system, a start of a time window in which the alert sound is expected to be output from the at least one audio output device and perceived by the occupant as a warning to the occupant, generate, by the alert detection system, a signal to output the alert sound from the at least one audio output device and in the time window, receive, by the alert detection system, audio data representing the plurality of acoustic sounds received via the at least one audio sensor, determine, by the alert detection system and using the received audio data, a score representing a likelihood the occupant perceived the alert sound as the warning, and generate an alert to gain attention of the occupant when the score indicates the occupant did not perceive the alert sound as the warning.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. In the figures, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A is a schematic illustration of an example environment including an example alert detection system for detecting whether an alert sound is audible in the environment, according to some embodiments described herein.

FIG. 1B is an illustration of an example vehicle including the alert detection system of FIG. 1A for detecting whether an alert sound is audible to a driver of the vehicle, according to some embodiments described herein.

FIG. 2 depicts an example implementation of the alert detection system of FIGS. 1A and/or 1B including an example score generator for determining a likelihood that an alert sound is perceptible in the environment of FIG. 1A and/or the vehicle of FIG. 1B, according to some embodiments described herein.

FIG. 3 depicts an example implementation of the score generator of FIG. 2, according to some embodiments described herein.

FIG. 4 is a flowchart representative of an example process to implement the alert detection system of FIGS. 1A, 1B, and/or 2 to determine a perceptibility of an alert sound as an alert in a vehicle, according to some embodiments described herein.

FIG. 5 is a flowchart representative of an example process to implement the alert detection system of FIGS. 1A, 1B, and/or 2 to process audio detected in a vehicle, according to some embodiments described herein.

FIG. 6 is a flowchart representative of an example process to implement the alert detection system of FIGS. 1A, 1B, and/or 2 to determine a score indicative of the perceptibility of an alert sound as an alert to an occupant in a vehicle, according to some embodiments described herein.

FIG. 7 is an example electronic platform structured to execute the machine-readable instructions of FIGS. 4, 5, and/or 6 to implement the alert detection system of FIGS. 1A, 1B, and/or 2, according to some embodiments described herein.

### DETAILED DESCRIPTION

Implementations of the subject matter described in this disclosure may be used to improve safety for vehicle occupants by eliminating or at least mitigating safety concerns with a vehicle's safety alert system. Some examples described herein provide for a vehicle safety alert system configured to play an alert sound to gain an occupant's attention when changes in certain vehicle functions are to occur. Safety may be reduced if the occupant is unaware of the changes to the vehicle functions because the alert sound is not perceivable to the occupant as an alert (e.g., a warning). For example, the alert sound may not be perceivable to the occupant when the alert sound is inaudible or not sufficiently audible to convey the alert sound as an alert to the vehicle occupant.

To improve occupant safety, the disclosure provides some examples for detecting whether the alert sound is perceivable to an occupant as an alert. The disclosure provides some examples for performing alert action(s), which may be escalatory, to notify the occupant when the alert sound is determined not to be perceivable or sufficiently perceivable to the occupant. In some examples, safety concerns with the vehicle safety alert system are eliminated when the alert sound is confirmed to be perceivable as an alert to an occupant and the vehicle safety alert system is thereby confirmed to be operating as intended. In some examples, safety concerns with the vehicle safety alert system are mitigated when the alert sound is not perceivable as an alert by performing alert action(s) to obtain the occupant's attention such that the occupant is aware of the impending vehicle function changes.

The described implementations may be implemented in a vehicle, such as by determining whether an alert sound, such as a chime (or any other sound), is output from a speaker in the vehicle and is perceivable as an alert to an occupant of the vehicle. An occupant of a vehicle (i.e., a vehicle occupant) may be a driver or a passenger. By ensuring that the occupant hears the chime (and thereby perceives the chime as an alert), the occupant can provide increased attention for a vehicle operation to be performed as indicated by the chime sound, which leads to enhanced safety for the vehicle occupant(s).

Although the described implementations may be implemented in a vehicle, the disclosure is not so limited. Other examples of alert detection may include determining whether an alert sound, such as an alarm, is output from a public warning system in an airport, a commercial building, a school, a train station, or the like, and that the alarm is audible to person(s) in such environments.

An example use case for the described implementations is operating a vehicle in a driver assistance mode, such as an autonomous mode. For example, the occupant of the vehicle may be a driver of a vehicle and the driver may transition the vehicle from manual mode to autonomous mode. Manual mode may involve the driver controlling the vehicle using the steering wheel and associated controls. Autonomous mode may involve the vehicle controlling itself using autonomous driving systems.

In such a use case, the vehicle may determine to return to manual mode, such as by detecting an upcoming congested traffic area. Prior to returning to manual mode, the vehicle may use an alert sound system to output an alert sound (e.g., a chime or any other sound) using the vehicle speakers. Upon hearing the alert sound, the driver may perceive the alert sound as understanding that the vehicle is about to revert to manual mode and needs increased attention to controlling the vehicle for safety, such as by gaining control of the vehicle steering wheel. It should be understood that the above use case is merely an example and implementations of the subject matter described herein is not so limited.

Examples of alert detection (or alert perception) described herein overcome shortcomings of prior techniques for detecting a failure of vehicle safety systems, such as an alert sound system as described above. Prior techniques for detecting a failure of an embedded system are inadequate to determine whether a vehicle driver is able to hear an alert sound and perceive the alert sound as an alert in some real-world situations. For example, prior techniques may identify a general system failure of an embedded system by periodically polling the embedded system for an operational status, monitoring the value of a data counter (e.g., a watchdog timer) implemented by the embedded system, or the like. However, prior techniques are unable to detect whether an alert sound is perceptible to a vehicle driver as an alert when the underlying embedded system is operational.

By way of example, an alert sound is not perceptible to a vehicle occupant when a speaker system of a vehicle is broken at least in part while an embedded system controlling the speaker system is operational. The speaker system may be broken by not outputting sound from vehicle speaker(s). The speaker system may also be broken by outputting sound from the vehicle speaker(s) but with an insufficient power output such that sound from the vehicle speaker(s) may be inaudible to human ears. In these examples, the prior techniques may not detect a fault condition indicative of a speaker system failure because (i) the embedded system controlling the speaker system is operational and/or (ii) the embedded system is not able to verify audio output from the vehicle system(s). Accordingly, the prior techniques do not properly identify problems of the speaker system, which can cause a lack of perceptibility by the vehicle occupant of the alert sound as an alert. Since the prior techniques cannot properly identify such speaker system problems, the prior techniques are incapable of eliminating or at least mitigating these problems, which thereby decrease safety for vehicle occupant(s).

By way of another example, noisy environmental conditions may also prevent a vehicle occupant from perceiving an alert sound as an alert. Examples of noisy environmental conditions include loud noises from surrounding vehicles, music external to the vehicle, noise from a crowd of people nearby, road construction noise, and weather conditions (e.g., wind noise). Examples of loud noises from surrounding vehicles include emergency vehicle sirens, semi-trailer truck horns, and music from vehicle speakers. Such noisy environmental conditions may conceal and/or suppress audibility of an alert sound such that a vehicle occupant may not perceive the alert sound as an alert. Accordingly, the prior techniques are incapable of determining whether a vehicle occupant perceived an alert sound as an alert in such noisy environmental conditions. Since the prior techniques cannot determine if a vehicle occupant perceived an alert sound as an alert in noisy environmental conditions, the prior techniques are incapable of eliminating or at least mitigating these problems, which thereby decrease safety for vehicle occupant(s).

Beneficially, implementations of the subject matter described in this disclosure overcome the inabilities and/or insufficiencies of the prior techniques by determining whether an alert sound is perceptible to a vehicle occupant as an alert and executing mitigation measures in case the alert sound is not perceptible as an alert. Examples described herein include listening for the alert sound and determining whether the alert sound is sufficiently audible such that the alert sound is perceptible to the vehicle occupant as an alert.

In some embodiments, an alert detection system determines to output an alert sound using at least one speaker of a vehicle. Responsive to the determination, the alert detection system can record acoustic sounds that include the outputted alert sound using at least one microphone in a listening environment, such as an interior of the vehicle. The recorded acoustic sounds may include environment sounds and/or the alert sound. Examples of the environment sounds include sounds internal to the vehicle, such as human speech and music, and sounds external to the vehicle.

Some embodiments involve the alert detection system receiving an acoustic sound signal representing the acoustic sounds. The alert detection system can detect that the acoustic sound signal, or portion(s) thereof, correspond to the alert sound. For example, the alert detection system can detect that the acoustic sound signal corresponds to the alert sound by comparing the acoustic sound signal to a pre-recording of the alert sound. In such an example, the greater the similarity between the acoustic sound signal and the pre-recording of the alert sound, the greater the likelihood that the acoustic sound signal corresponds to the alert sound.

The alert detection system can determine a score representing a likelihood the vehicle occupant perceived the alert sound as an alert (e.g., a warning). For example, the alert detection system can determine the score by comparing the acoustic sound signal to the pre-recording of the alert sound for similarity. The alert detection system can determine, using the score, that the alert sound was output from the vehicle speaker(s) and sufficiently loud and/or clear enough for the vehicle driver to hear. By determining that the alert sound was sufficiently loud and/or clear enough for the vehicle driver to hear, the alert detection system can determine that the alert sound was sufficiently perceptible to the vehicle occupant as an alert. Beneficially, the alert detection system eliminates safety concerns associated with a vehicle safety alert system by confirming that the system outputs alert sounds as expected and thereby confirms that the system is operating as intended.

In some embodiments, the alert detection system determines, using the score, that the alert sound is not perceptible to a vehicle occupant as an alert. In some such embodiments, the alert detection system mitigates safety concerns with a vehicle safety alert system by performing one or more alert actions to gain the occupant's attention.

Examples of alert actions include a visual alert and a haptic alert. An example of a visual alert includes one or more graphics, such as visual graphics, for display on one or more display devices of the vehicle. Examples of a haptic alert include vibrating a steering wheel and vibrating a seat in which an occupant sits. In some embodiments, multiple alert actions are executed simultaneously. For example, a display device may display a visual alert of changes to a vehicle function and an occupant's seat may vibrate.

In some embodiments, alert actions may be performed in sequence such that an urgency to obtain the occupant's attention is escalated. For example, a visual alert may be generated and, if the occupant does not acknowledge the visual alert, a haptic alert may be generated after the visual alert.

Implementations of the subject matter described in this disclosure provide multiple benefits over the prior techniques. First, the alert detection system can be configured to determine the score with reduced latency. For example, the alert detection system can reduce latency by processing a pre-recording of the alert sound in advance and storing the result such that the pre-recording is processed a single time.

Second, the alert detection system can be configured to determine the score with reduced consumption of physical hardware system resources (e.g., processing power, memory, storage). For example, the alert detection system can compress the acoustic sound signal captured by the microphone and the pre-recording of the alert sound. In such an example, the alert detection system can execute a comparison of the compressed data faster and with fewer system resources than performing a comparison using non-compressed data. By way of another example, the alert detection system can determine the score in response to a trigger signal to reduce consumption of physical hardware system resources. For example, unnecessary physical hardware system resources are consumed if scores are determined during time windows when the alert sound is not expected to be detected. By determining the score after receiving the trigger signal, the alert detection system can utilize physical hardware system resources in time windows when the alert sound is expected rather than in time windows when the alert sound is not expected.

Beneficially, vehicle occupant safety is improved by detecting an alert sound and determining that the alert sound is perceptible to a vehicle occupant as an alert such that the vehicle occupant increases attention to a vehicle condition conveyed by the alert sound. Vehicle occupant safety is improved by performing alert action(s) to gain the attention of an occupant if an alert sound is determined not to be perceptible. Vehicle occupant safety is improved in this way rather than relying on the detection of an operational status of an underlying embedded system or a hardware failure. Advantageously, the implementations of the subject matter described in this disclosure can accurately diagnose the entire listening environment as well as any hardware failure that can cause the imperceptibility of an alert sound.

The subject matter described in this disclosure may be implemented in any of numerous ways, as the subject matter is not limited to any particular manner of implementation. Examples of details of implementation are provided herein solely for illustrative purposes. Furthermore, the subject matter described in this disclosure may be used individually or in any suitable combination, as aspects of the subject matter described herein are not limited to the use of any particular technique or combination of techniques.

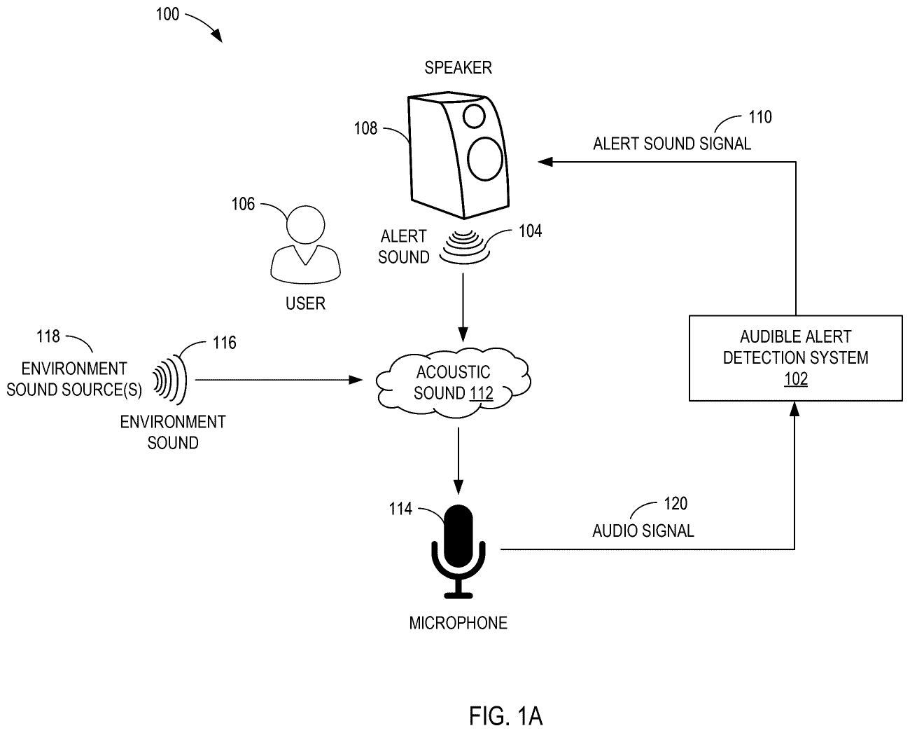

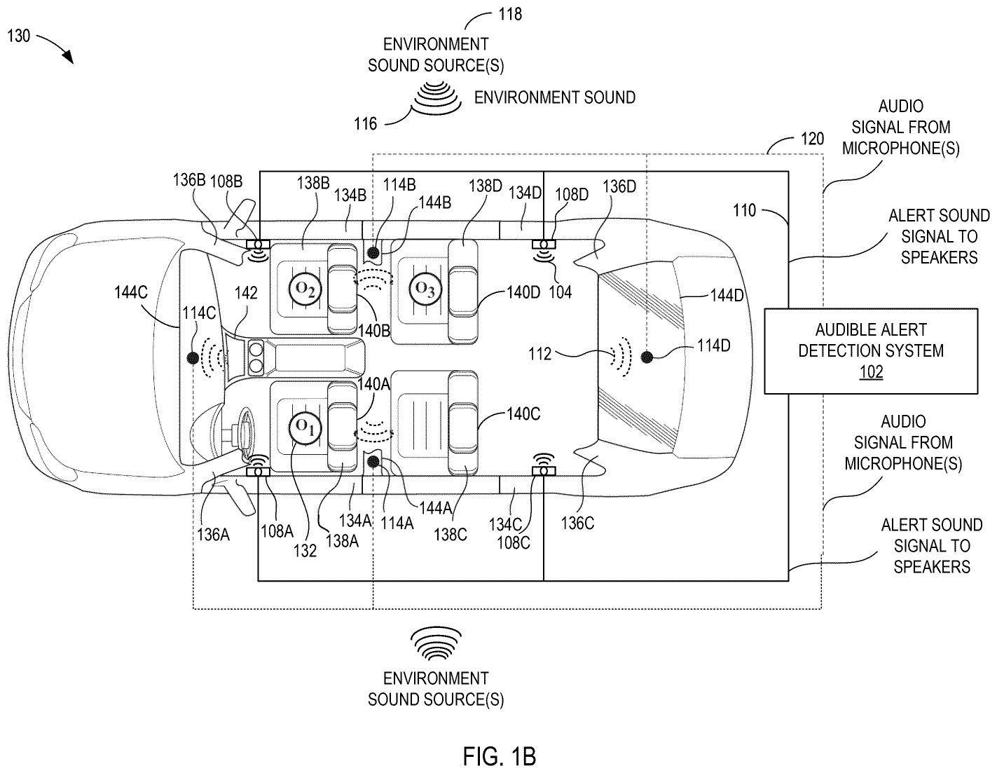

Turning to the figures, the illustrated example of FIG. 1A is a schematic illustration of an example environment 100 including an example alert detection system 102 for detecting whether an alert sound 104 is perceptible to a user 106 in the environment 100. The environment 100 of this example may be a system including one or more aspects or components as shown. For example, the environment 100 may be a vehicle (e.g., a vehicle system), such as an interior of the vehicle including the audible alert detection system 102 and the user 106. In such an example, the user 106 may be an occupant of the vehicle. An occupant may be a driver (e.g., a vehicle driver) or a passenger (e.g., a vehicle passenger). Alternatively, the environment 100 may be any other surroundings in which alert sounds may be heard. Examples of such environments include airports, schools, and train stations.

In the illustrated example, the alert detection system 102 is an audible alert detection system. The audible alert detection system 102 is configured to determine whether the alert sound 104 is audible and/or sufficiently audible to the user 106 such that the alert sound 104 is perceived by the user 106 as an alert. The audible alert detection system 102 can cause an audio output device 108 to output the alert sound 104 to convey and/or indicate to the user 106 that increased attention is needed. For example, the audible alert detection system 102 may cause the alert sound 104 to be generated to inform the user 106 that an autonomous mode of the vehicle is to be either engaged or disengaged. In another example, the alert sound 104 may be generated in a different environment, such as a school, that an emergency is underway (e.g., a fire alarm).

In the shown example, the audible alert detection system 102 outputs an alert sound signal 110 that, when received by the audio output device 108, causes the audio output device 108 to play the alert sound 104. For example, the audible alert detection system 102 can generate a signal, such as the alert sound signal 110, to control audible output of the alert sound 104 in the vehicle.

Examples of the alert sound 104 include a chime, a chirp, a ding, and a ring sound. For example, the audible alert detection system 102 may be a chime alert monitoring system configured to detect whether a chime alert is output from the audio output device 108 and that the chime alert is perceptible as an alert to the user 106 in the environment 100. Alternatively, the alert sound 104 may be any other type of sound indicative of an alert for heightened and/or increased attention.

The audio output device 108 is configured to output audio in the form of sound waves. In the shown example, the audio output device 108 is a speaker. For example, the speaker 108 can be configured to generate and/or output sound, such as the alert sound 104. In some aspects, the speaker 108 may be an in-vehicle speaker within an infotainment system or a multimedia system of the vehicle to play the alert sound 104 for the user 106 so the user 106 can hear the alert sound 104 as long as the user 106 is in the environment 100. In some other aspects, the speaker 108 may be speaker(s) on a personal listening device of the user 106, such as hearing aids, headphones, or earbuds, so as the user 106 would hear the alert sound 104 via this personal listening device. Although only one speaker is shown in FIG. 1A for clarity, any other number of speakers may be used.

Beneficially, the audible alert detection system 102 promotes enhanced safety for the user 106 by determining whether the alert sound 104 is output from the audio output device 108 and perceptible to the user 106 as an alert. In the shown example, the audible alert detection system 102 determines whether the alert sound 104 is detected in acoustic sound 112 captured and/or received by an audio sensor 114. By determining that the alert sound 104 is detected in the acoustic sound 112, the audible alert detection system 102 can achieve enhanced safety by determining that a vehicle safety alert system of the vehicle is operating as intended, such as to play the alert sound 104 to inform the user 106 of impending changes to certain vehicle function(s).

The acoustic sound 112 of this example represents sound from one or more sound sources that can be detected by the audio sensor 114. For example, the acoustic sound 112 can represent a plurality of acoustic sounds present in the vehicle. As shown, the acoustic sound 112 can include the alert sound 104 and/or environment sound 116. The environment sound 116 can be generated and/or otherwise originate from one or more environment sound sources 118.

Examples of environment sound source(s) 118 include sounds internal to the vehicle and sounds external to the vehicle. Examples of sounds external to the vehicle include sounds from surrounding vehicles, music, noise from a crowd of people nearby, road construction noise, and weather conditions (e.g., rain noise, wind noise). For example, the environment sound source(s) 118 may be one or more surrounding vehicles that make loud noise. Examples of loud noise from surrounding vehicles include emergency vehicle sirens, semi-trailer truck horns, passenger vehicle horns, and music from vehicle speakers.

The audible alert detection system 102 determines the perceptibility of the alert sound 104 by the user 106 by processing an audio signal 120 from the audio sensor 114. The audio sensor 114 of the depicted example is a microphone. For example, the microphone 114 can detect the acoustic sound 112 and output an electrical representation of the acoustic sound 112 as the audio signal 120. Alternatively, the audio sensor 114 may be a piezoelectric transducer. Although only one microphone is shown in FIG. 1A for clarity, any other number of microphones may be used.

Responsive to receiving the audio signal 120, the audible alert detection system 102 can process the audio signal 120 for alert sound perceivability by the user 106. In some embodiments, the audible alert detection system 102 can process the audio signal 120 to generate audio data representing at least a portion of the acoustic sound 112, which can include a plurality of acoustic sounds present in the vehicle. The audible alert detection system 102 can determine, using the audio data, a score representing a likelihood (e.g., a probability) the user 106 perceived the alert sound 104 as an alert. In some aspects, the score represents a degree to which the acoustic sound 112 corresponds to the alert sound 104 and the alert sound 104 is sufficiently audible to the user 106 in the environment 100 (e.g., the vehicle) such that the user 106 perceives the alert sound 104 as an alert.

In some embodiments, the audible alert detection system 102 can determine whether the score satisfies a threshold. The threshold can represent a likelihood at and/or above which the user 106 perceives the alert sound 104 as an alert. For example, the threshold can represent a degree at and/or above which that the acoustic sound 112 includes the alert sound 104 and is sufficiently audible such that the user 106 can hear the alert sound 104 and perceive the alert sound 104 as an alert.

By way of example, the audible alert detection system 102 can determine that the acoustic sound 112 includes the alert sound 104 and is sufficiently audible such that the user 106 can hear the alert sound 104 and perceive the alert sound 104 as an alert when the score meets and/or exceeds the threshold. In such an example, the audible alert detection system 102 can determine that the vehicle safety alert system, which may include the speaker 108, is operating as intended when the score meets and/or exceeds the threshold.

In some embodiments, the audible alert detection system 102 can determine that the acoustic sound 112 does not include the alert sound 104 such that the user 106 cannot hear the alert sound 104 (and thereby does not perceive the alert sound 104 as an alert) when the score does not meet and/or exceed the threshold. For example, the audible alert detection system 102 can determine that the vehicle safety alert system, which may include the speaker 108, is not operating as intended due to a fault condition when the score does not meet and/or exceed the threshold. In such an example, the audible alert detection system 102 can detect a fault condition associated with a source of the alert sound 104 when the score does not meet and/or exceed the threshold.

Examples of the source of the alert sound 104 include the audio output device 108, an embedded system in communication with the audio output device 108, and the audible alert detection system 102. For example, the audible alert detection system 102 can determine that the score not meeting and/or exceeding the threshold indicates a failure of the audio output device 108, a failure of the embedded system in communication with the audio output device 108, and/or a failure of the audible alert detection system 102.

In some embodiments, the audible alert detection system 102 can perform one or more alert actions to mitigate a detected fault condition, such as a failure of the speaker 108, to maintain safety for the user 106. For example, the audible alert detection system 102 can provide a visual alert on display device(s) of the vehicle and/or provide haptic feedback to the user 106. Examples of a haptic alert include vibrating a steering wheel and vibrating a seat in which the user 106 sits. In some embodiments, the audible alert detection system 102 can perform the one or more alert actions in an escalatory manner to obtain the attention of the user 106. For example, the audible alert detection system 102 can, in sequence, display a visual alert on display device(s) of the vehicle followed by providing haptic feedback to the user 106. In another example, the audible alert detection system 102 can, in combination, perform alert actions such as by displaying a visual alert on display device(s) of the vehicle and providing haptic feedback to the user 106.

In some embodiments, the audible alert detection system 102 can determine that the alert sound 104 is in the acoustic sound 112 but is not sufficiently audible such that the user 106 can hear the alert sound 104 when the score does not meet and/or exceed the threshold. For example, the audible alert detection system 102 can determine that the vehicle safety alert system is outputting the alert sound 104 but the score indicates that the environment sound 116 is concealing and/or suppressing audibility of the alert sound 104 such that the alert sound 104 is not sufficiently audible to the user 106. In such an example, a siren from an emergency vehicle passing by the vehicle of the user 106 at the time of playing the alert sound 104 may conceal and/or suppress the alert sound 104 from being heard by the user 106. When the alert sound 104 is not sufficiently audible to the user 106, it is with a low likelihood that the user 106 perceives the alert sound 104 as an alert.

In some embodiments, the audible alert detection system 102 can perform one or more alert actions to mitigate the concealment/suppressing of the alert sound 104 to maintain safety for the user 106. For example, the audible alert detection system 102 can replay the alert sound 104, change aspect(s) of the alert sound 104, provide a visual alert, and/or provide haptic feedback to the user 106.

Examples of aspect(s) of the alert sound 104 include a duration of the alert sound 104, a type of the alert sound 104, a volume of the alert sound 104, and a frequency at which the alert sound 104 is played. For example, the audible alert detection system 102 can change the aspect(s) of the alert sound 104 by changing the type of alert sound 104 being output from a chime alert sound to a ring alert sound (e.g., a ringing alert sound). In another example, the audible alert detection system 102 can change the aspect(s) of the alert sound 104 by increasing the volume of the alert sound 104.

In some embodiments, the audible alert detection system 102 can perform the one or more alert actions in an escalatory manner to obtain the attention of the user 106. For example, the audible alert detection system 102 can, in sequence, replay the alert sound 104, change aspect(s) of the alert sound 104, display a visual alert on display device(s) of the vehicle, and ultimately provide haptic feedback to the user 106. In another example, the audible alert detection system 102 can, in combination, perform two or more of the following: replay the alert sound 104, change aspect(s) of the alert sound 104, display a visual alert on display device(s) of the vehicle, and provide haptic feedback to the user 106.

An example of a visual alert includes one or more graphics, such as visual graphics, for display on one or more display devices of the vehicle. For example, the audible alert detection system 102 may cause the one or more graphics to be displayed on the one or more display devices of the vehicle. In some embodiments, the audible alert detection system 102 may cause the graphic(s) to be displayed on the display device(s) by outputting a signal (e.g., a control signal, a command signal) to a system that controls the display device(s) to display the graphic(s) on the display device(s). In some embodiments, the audible alert detection system 102 may cause the graphic(s) to be displayed on the display device(s) by outputting a signal (e.g., a control signal, a command signal) to the display device(s) to control the display device(s) to display the graphic(s).

Examples of a haptic alert include vibrating a steering wheel and vibrating a seat in which an occupant sits. In some embodiments, the audible alert detection system 102 may cause the vibration of the steering wheel and/or the seat by outputting a signal (e.g., a control signal, a command signal) to a system that controls the vibration actuator(s) of the steering wheel and/or the seat. In some embodiments, the audible alert detection system 102 may cause the vibration of the steering wheel and/or the seat by outputting a signal (e.g., a control signal, a command signal) to the vibration actuator(s) to control the vibration of steering wheel and/or the seat.

In some embodiments, multiple alert actions are executed simultaneously. For example, a display device may display a visual alert of changes to a vehicle function and an occupant's seat may vibrate. In some embodiments, alert actions may be performed in sequence such that an urgency to obtain the occupant's attention is escalated. For example, a visual alert may be generated and, if the occupant does not acknowledge the visual alert, a haptic alert may be generated after the visual alert.

FIG. 1B is an illustration of an example implementation of the environment 100 of FIG. 1A. The implementation shown in FIG. 1B is a vehicle 130, which includes the audible alert detection system 102 of FIG. 1A for detecting whether the alert sound 104 of FIG. 1A is perceptible as an alert to an occupant 132 of the vehicle 130. The occupant 132 is identified in FIG. 1B as a first occupant (O1). The occupant may be a driver of the vehicle 130. The vehicle 130 may include one or more other occupants identified by O2 and O3. In FIG. 1B, the audible alert detection system 102 is shown external to the vehicle 130 for clarity, but it should be understood that the audible alert detection system 102 is included in and/or integrated with the vehicle 130.

The vehicle 130 of the illustrated example is an automobile, such as a passenger vehicle. The passenger vehicle shown in FIG. 1B is a sedan. Alternatively, the passenger vehicle may be a sports utility vehicle, a station wagon, or a van. Alternatively, the vehicle 130 may be a commercial vehicle or a recreation vehicle.

Examples of commercial vehicles include semi-trailers and trucks (e.g., box trucks, pickup trucks). Examples of recreation vehicles include trailer coaches and park trailers. The techniques described herein are applicable to any type of vehicle, which may be classified by any type of propulsion. For example, the techniques described herein can be applicable to electric vehicles (EVs), plug-in electric vehicles (PEVs), battery electric vehicles (BEVs), hybrid electric vehicles (HEVs), plug in hybrid electric vehicles (PHEVs), fuel cell electric vehicles (FCEVs), plug in fuel cell vehicles (PFCVs), and internal combustion engine vehicles (ICEVs). For example, the vehicle 130 can be an electric sedan (e.g., a sedan EV).

The vehicle 130 shown in FIG. 1B has a vehicle speaker system that includes a plurality of speakers 108A, 108B, 108C, 108D for playing sound. For example, one(s) of the speakers 108A, 108B, 108C, 108D can play music, talk radio, or facilitate phone calls (e.g., conducting a phone call using BLUETOOTH®). One(s) of the speakers 108A, 108B, 108C, 108D can correspond to and/or be implemented by the audio output device 108 of FIG. 1A. For example, the audible alert detection system 102 can output the alert sound signal 110 to one(s) of the speakers 108A, 108B, 108C, 108D to cause the one(s) of the speakers 108A, 108B, 108C, 108D to play the alert sound 104 of FIG. 1A.

In the depicted example, the speakers 108A, 108B, 108C, 108D are integrated into assemblies (e.g., subassemblies) of the vehicle 130. For example, a first speaker 108A is assembled, integrated, and/or otherwise included in a first door assembly 134A of the vehicle 130. A second speaker 108B, a third speaker 108C, and a fourth speaker 108D are also shown in a second door assembly 134B, a third door assembly 134C, and a fourth door assembly 134D, respectively. The door assemblies 134A, 134B, 134C, 134D are doors of the vehicle 130. Alternatively, the door assemblies 134A, 134B, 134C, 134D may be portion(s) of the doors of the vehicle 130. For example, the door assemblies 134A, 134B, 134C, 134D can be door interior panels, subassemblies, or the like, in which a corresponding one of the speakers 108A, 108B, 108C, 108D may be installed.

The locations at which the speakers 108A, 108B, 108C, 108D are shown in FIG. 1B are merely example locations and one(s) of the speakers 108A, 108B, 108C, 108D may be installed elsewhere, such as in a frame (e.g., an A-frame) 136A, 136B, 136C, 136D, a seat 138A, 138B, 138C, 138D, a headrest 140A, 140B, 140C, 140D, and/or a console 142 of the vehicle 130. Further, although four of the speakers 108A, 108B, 108C, 108D are shown in FIG. 1B, fewer or more speakers than shown in FIG. 1B may be used.

In the illustrated example, the vehicle 130 includes a plurality of microphones 114A, 114B, 114C, 114D to capture, detect, and/or receive audio in the vehicle 130. For example, one(s) of the microphones 114A, 114B, 114C, 114D can be used for audible alert detection as described herein. For example, one(s) of the microphones 114A, 114B, 114C, 114D can receive acoustic sound that can include the alert sound 104 and the environment sound 116 from the environment sound source(s) 118. One(s) of the microphones 114A, 114B, 114C, 114D shown in FIG. 1B can correspond to and/or be implemented by the audio sensor 114 of FIG. 1A. For example, the audible alert detection system 102 can receive the audio signal 120 of FIG. 1A from one(s) of the microphones 114A, 114B, 114C, 114D.

In the depicted example, the microphones 114A, 114B, 114C, 114D are integrated into assemblies (e.g., subassemblies) of the vehicle 130. For example, a first microphone 114A is assembled, integrated, and/or otherwise included in a first assembly 144A behind and/or otherwise proximate the first headrest 140A. A second microphone 114B is shown in a second assembly 144B behind the second headrest 140B. A third microphone 114C is shown in a third assembly 144C, which may include at least part of the front windshield of the vehicle 130. A fourth microphone 114D is shown in a fourth assembly 144D, which may include least part of the rear windshield of the vehicle 130.

The locations at which the microphones 114A, 114B, 114C, 114D are shown in FIG. 1B are merely example locations and one(s) of the microphones 114A, 114B, 114C, 114D may be installed elsewhere, such as in one(s) of the frames 136A, 136B, 136C, 136D, one(s) of the seats 138A, 138B, 138C, 138D, one(s) of the headrests 140A, 140B, 140C, 140D, and/or the console 142 of the vehicle 130. Further, although four of the microphones 114A, 114B, 114C, 114D are shown in FIG. 1B, fewer or more microphones than shown in FIG. 1B may be used.

In an example operation, the audible alert detection system 102 can determine that the alert sound 104 is to be played in an interior of the vehicle 130. For example, the audible alert detection system 102 can determine that the vehicle 130, which may be in autonomous mode, is to be transitioned to manual mode. In another example, the audible alert detection system 102 can determine that the occupant 132 is attempting to change road lanes but there is another vehicle in the blind spot of the occupant 132 and the occupant 132 is to be alerted. In such examples, the audible alert detection system 102 is to cause the alert sound 104 to be played in the vehicle 130 such that the occupant 132 may become aware of the upcoming transition from autonomous mode to manual mode. For example, the audible alert detection system 102 can trigger a start of a time window in which the alert sound 104 is expected to be audible to the occupant 132. In such an example, the audible alert detection system 102 can generate a signal to control audible output of the alert sound 104 in the vehicle 130 and in the time window.

In an example operation, the audible alert detection system 102 outputs the alert sound signal 110 to one(s) of the speakers 108A, 108B, 108C, 108D. The audible alert detection system 102 can receive the acoustic sound 112 from one(s) of the microphones 114A, 114B, 114C, 114D. The audible alert detection system 102 can generate audio data representing at least a portion of a plurality of acoustic sounds present in the vehicle, such as the acoustic sound 112. The audible alert detection system 102 can determine, using the audio data in the time window, a score indicating a likelihood that the occupant 132 perceives the alert sound 104 as an alert. In some aspects, the score can represent a degree to which at least a portion of the acoustic sound 112 corresponds to the alert sound 104 and that the alert sound 104 is audible to the occupant 132.

In some embodiments, if the audible alert detection system 102 determines that the score meets and/or exceeds a threshold, the audible alert detection system 102 determines that the vehicle safety alert system, which may include at least part of the vehicle speaker system, is operational and functioning as intended. For example, the audible alert detection system 102 can determine that the vehicle safety alert system is operational and functioning as intended by determining that the acoustic sound 112 includes the alert sound 104 and is sufficiently audible such that the occupant 132 can hear the alert sound 104 and perceive the alert sound 104 as an alert.

In some embodiments, if the audible alert detection system 102 determines that the score falls beneath the threshold, the audible alert detection system 102 can determine that the acoustic sound 112 does not include the alert sound 104 such that the occupant 132 cannot hear the alert sound 104 (and thereby cannot perceive the alert sound 104 as an alert). For example, the audible alert detection system 102 can determine that the alert sound 104 is not output from the speakers 108A, 108B, 108C, 108D due to a fault condition. Examples of a fault condition include one(s) of the speakers 108A, 108B, 108C, 108D being broken, cable(s) or other electrical connection(s) associated with the speakers 108A, 108B, 108C, 108D is/are broken, and an embedded system controlling the speakers 108A, 108B, 108C, 108D is broken.

Responsive to detecting the fault condition, the audible alert detection system 102 may perform one or more alert actions to maintain safety for the occupant 132. An example of an alert action is generating an alert for presentation to the occupant 132 via at least one graphic (e.g., visual graphic) on a graphical user interface (GUI) on at least one display device in the vehicle 130. Another example of an alert action is providing haptic feedback to the seat 138A in which the occupant 132 sits, providing haptic feedback to the headrest 140A on which the occupant 132 rests their heat, and/or the console 142 on which the occupant 132 may be touching. Yet another example of an alert action is causing transmission of the alert to a central facility, such as a vehicle service center. In some embodiments, responsive to receiving the alert, the central facility may contact the occupant 132 (e.g., when the occupant 132 is no longer driving the vehicle 130) to schedule an appointment to conduct maintenance and/or repair operations on the vehicle 130 to identify and repair the root cause of the detected fault condition.

In some embodiments, if the audible alert detection system 102 determines that the score falls beneath the threshold, the audible alert detection system 102 can determine that the alert sound 104 is not perceptible (e.g., sufficiently perceptible) to the occupant 132 as an alert, such as the environment sound 116 concealing the alert sound 104 from being sufficiently audible. For example, the audible alert detection system 102 can determine that the vehicle safety alert system is outputting the alert sound 104 but the score indicates that the environment sound 116 is concealing and/or suppressing perceptibility of the alert sound 104 as an alert because the alert sound 104 is not sufficiently audible to the user 106. In such an example, loud music from a surrounding vehicle at the time of playing the alert sound 104 may conceal and/or suppress the alert sound 104 from being heard by the occupant 132.

In some embodiments, the audible alert detection system 102 can perform one or more alert actions to mitigate the concealment/suppressing of the alert sound 104 to maintain safety for the occupant 132. For example, the audible alert detection system 102 can replay the alert sound 104, change aspect(s) of the alert sound 104, provide a visual alert, and/or provide haptic feedback to the occupant 132. In some embodiments, the audible alert detection system 102 can perform the one or more alert actions simultaneously or in an escalatory manner to obtain the attention of the occupant 132 to apprise the occupant 132 of changes to certain vehicle function(s).

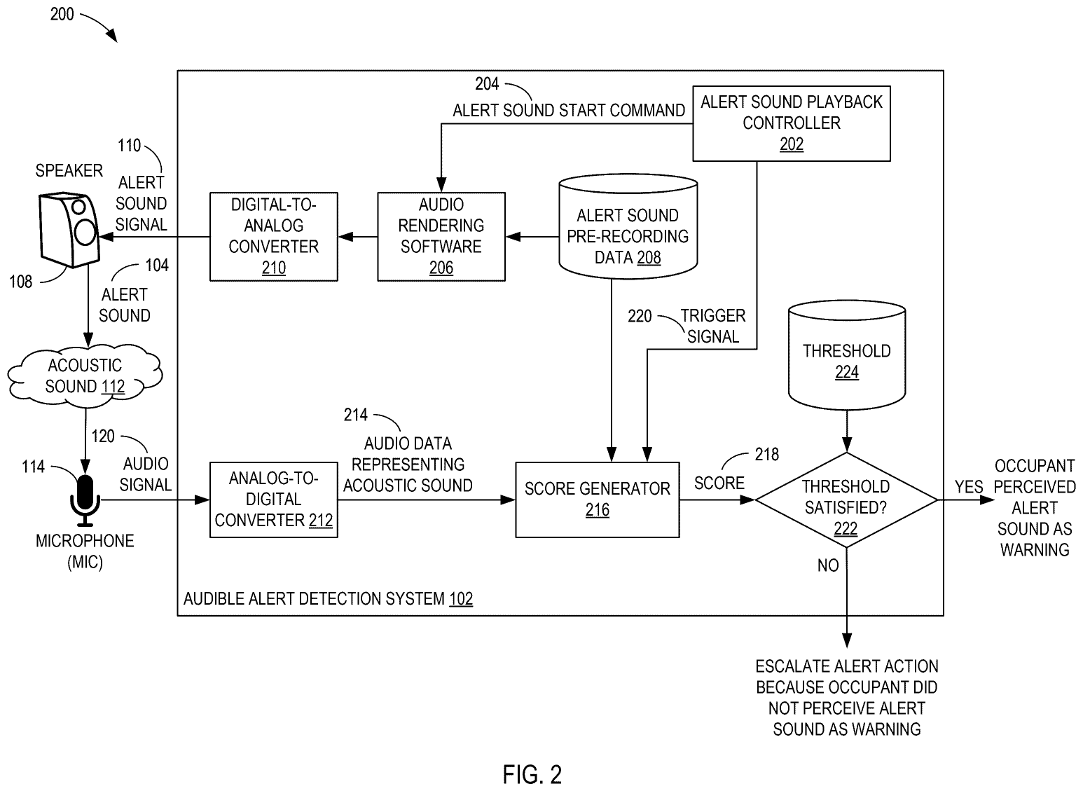

FIG. 2 depicts an environment 200 including an example implementation of the audible alert detection system 102 of FIG. 1A. For example, the environment 200 can correspond to the environment 100 of FIG. 1A and/or the vehicle 130 of FIG. 1B. Furthering the example, the environment 200 shown in FIG. 2 may be the vehicle 130 of FIG. 1B. The environment 200 shown in FIG. 2 further includes the audio output device 108 and the audio sensor 114 of FIG. 1A.

Additionally or alternatively, the environment 200 may include one(s) of the speakers 108A, 108B, 108C, 108D of FIG. 1B and/or one(s) of the microphones 114A, 114B, 114C, 114D of FIG. 1B. Although the speaker 108 and the microphone 114 are depicted separate from the audible alert detection system 102, in other embodiments, the audible alert detection system 102 may include the speaker 108 and/or the microphone 114. Further, in some embodiments, the audible alert detection system 102 may include the speaker 108, the microphone 114, one(s) of the speakers 108A, 108B, 108C, 108D of FIG. 1B, and/or one(s) of the microphones 114A, 114B, 114C, 114D of FIG. 1B.

The audible alert detection system 102 of the illustrated example can be configured to determine whether portion(s) of the acoustic sound 112 correspond to the alert sound 104 and a likelihood that the alert sound 104 is perceptible as an alert to a person, such as the occupant 132 of FIG. 1B. For example, the acoustic sound 112 can be implemented and/or include a plurality of acoustic sounds present in the vehicle 130 of FIG. 1B. In such an example, the audible alert detection system 102 of FIG. 2 can be configured to determine whether at least one sound of the plurality of acoustic sounds is the alert sound 104.

The alert sound 104 is shown in FIG. 2 to be generated by way of control from an alert sound playback controller 202. The audible alert detection system 102 includes the alert sound playback controller 202, which can be implemented by a combination of hardware, software, and/or firmware. For example, the alert sound playback controller 202 may be implemented at least in part by an embedded system, such as a vehicle embedded system. An example of a vehicle embedded system is an electronic control unit (ECU) (also referred to as an “electronic control module” or “ECM”).

The alert sound playback controller 202 is shown to generate and/or output an alert sound start command 204. The alert sound start command 204 can be implemented by an electrical control signal and/or communication data (e.g., communication transmitted using a data bus) representative of an instruction to effectuate the output of the alert sound 104 from the audio output device 108.

In the illustrated example, audio rendering software 206 receives the alert sound start command 204 from the alert sound playback controller 202. After receiving the alert sound start command 204, the audio rendering software 206 retrieves alert sound audio data 208. The alert sound audio data 208 is reference audio data. The reference audio data is a pre-recording of the alert sound 104. For example, the alert sound audio data 208 may be reference audio data to be compared with audio data representing the acoustic sound 112. In such an example, the comparison may lead to a determination of whether the acoustic sound 112 includes a sound that resembles, closely matches, and/or matches the alert sound 104 represented by the reference data. Examples of the alert sound audio data 208 is data representing a chime, a chirp, a ding, or a ring. In some embodiments, the alert sound audio data 208 can be 16-bit data at 48 kilohertz (kHz).

The alert sound audio data 208 is shown to be stored in a datastore. For example, the datastore may be implemented by computer memory and/or one or more mass storage devices. Alternatively, the audio rendering software 206 may dynamically generate the alert sound audio data 208.

The audio rendering software 206 outputs the alert sound audio data 208 to a digital-to-analog converter (DAC) 210. The DAC 210 can convert the alert sound audio data 208 from a digital representation to an analog representation, such as an analog output signal (e.g., a voltage). The analog representation in this example is the alert sound signal 110. For example, the DAC 210 outputs the alert sound signal 110 to the speaker 108 which, in turn, plays the alert sound 104 in the environment 200.

The audio sensor 114 in the depicted example captures, detects, and/or receives the acoustic sound 112. At least part of the acoustic sound 112 may include the alert sound 104. The audio sensor 114 outputs the acoustic sound 112 as the audio signal 120 to an analog-to-digital converter (ADC) 212. The ADC 212 converts the audio signal 120 from an analog representation to a digital representation. The digital representation in this example is acoustic sound audio data 214. The acoustic sound audio data 214 shown in FIG. 2 represents acoustic sound, such as the acoustic sound 112. An example of the acoustic sound audio data 214 include pulse code modulation (PCM) data. In some embodiments, the acoustic sound audio data 214 may be 16-bit PCM data at 48 KHz.

It is to be understood that in some embodiments, the audible alert detection system 102 does not include any DACs 210 or ADCs 212. In other words, the DACs 210 and ADCs 212 in such embodiments are separate from, not a part of, the audible alert detection system 102.

The audible alert detection system 102 receives the acoustic sound audio data 214 from the ADC 212. The audible alert detection system 102 includes a score generator 216 for determining and/or outputting a score 218 using one or more of a plurality of inputs. The score 218 may be a perception score (e.g., a perceptibility score). For example, a perception score can represent a likelihood that a user, such as the occupant 132, perceived the alert sound 104 as an alert. The score 218 may be an audible score (e.g., an audibility score). For example, an audible score can represent a degree to which the acoustic sound 112 (e.g., the acoustic sound audio data 214 representing the acoustic sound 112) corresponds to the alert sound 104 and the alert sound 104 is audible in the environment 200 such that the user can perceive the alert sound 104 as an alert.

In the illustrated example, a first input to the score generator 216 is the audio data 214. A second input to the score generator 216 is the alert sound audio data 208. For example, the score generator 216 can perform a comparison of the acoustic sound audio data 214 and the alert sound audio data 208 and determine the score 218 using the comparison.

A third input to the score generator 216 is a trigger signal 220 from the alert sound playback controller 202. In the shown example, the alert sound playback controller 202 generates the trigger signal 220 to trigger a start of a time window in which the alert sound 104 is expected and/or anticipated to be audible to the occupant 132 of the vehicle 130. For example, in response to the trigger signal 220, the score generator 216 may begin processing the acoustic sound audio data 214.

The trigger signal 220 reduces consumption of processing resources by the score generator 216 because the score generator 216 may process the acoustic sound audio data 214 when the trigger signal 220 is received and may not process the acoustic sound audio data 214 otherwise.

Additionally, the trigger signal 220 may provide advance notification to the score generator 216 that the alert sound 104 is expected to be played from the speaker 108. The advance notification causes the score generator 216 to begin processing the acoustic sound audio data 214 and to detect whether the alert sound 104 is present in the acoustic sound 122. Because processing latency of the audio rendering software 206 and the DAC 210 and transmission latency between electrical components can cause a time gap between the generation of the alert sound start command 204 and the speaker 108 playing the alert sound 104, by providing the trigger signal 220 in conjunction with the alert sound start command 204, while taking into account the time gap due to latency, the score generator 216 can ensure a detection that the acoustic sound audio data 214 includes the alert sound 104 if present in the acoustic sound 112. In this way, the vehicle system described in this disclosure can execute a vehicle action (e.g., changing from autonomous to manual mode) when the alert sound 104 is determined to be perceived by the occupant 132 as an alert and thereby improve occupant safety.

Further, in this way, the vehicle system described in this disclosure has improved accuracy of alert sound detection such that false positive detections are substantially reduced. A “false positive detection” may refer to the occupant 132 not perceiving the alert sound 104 as an alert and the audible alert detection system 102 detecting the alert sound 104. When this happens, the vehicle 130 incorrectly assumes that the occupant 132 perceived the alert correctly and takes no escalatory action. When the occupant 132 is not well alerted by the alert sound 104, such false positive detections may mislead the vehicle system by not triggering functions such as escalated alerts to ensure the occupant 132 is well alerted by the alert sound 104.

Further, in this way, the vehicle system described in this disclosure has improved accuracy of alert sound detection such that false negative detections are substantially reduced. A “false negative detection” may refer to the occupant 132 perceiving the alert sound 104 as an alert and the audible alert detection system 102 not detecting the alert sound 104. When this happens, the vehicle 130 incorrectly assumes that the occupant 132 did not perceive the alert correctly and takes escalatory action. When the occupant 132 is well alerted by the alert sound 104 and the audible alert detection system 102 does not detect the alert sound 104, such false negative detections may mislead the vehicle system by triggering functions such as escalated alerts. These escalated alerts may result from the audible alert detection system 102 overreacting and such additional alerts in addition to the alert sound 104 may cause discomfort to the occupant 132.

In some embodiments, the alert sound playback controller 202 outputs the alert sound start command 204 and the trigger signal 220 substantially simultaneously. For example, due to the time gap, the score generator 216 can begin processing the acoustic sound audio data 214 to ensure that the alert sound 104 is not missed. Alternatively, the alert sound playback controller 202 may output the trigger signal 220 prior to outputting the alert sound start command 204.

The term “substantially simultaneously” may refer to occurrence in a near instantaneous manner recognizing there may be real-world delays for computing time, transmission, etc. For example, the alert sound playback controller 202 may output the alert sound start command 204 and the trigger signal 220 within 1 second, 500 milliseconds, 100 milliseconds, 10 milliseconds, etc., of real time.

The audible alert detection system 102 of the illustrated example analyzes, during one or more processing operations 222, whether the score 218 satisfies a threshold, such as the threshold 224. For example, the score 218 can be quantified using a numerical value in a range from 0 to 100. The threshold 224 may have a numerical value of 70 that, at or above which, represents that at least a part of the acoustic sound 112 includes the alert sound 104 and the alert sound 104 is audible to a person.

A numerical value of 70, for example, may be empirically derived. Empirical derivations may include playing a variety of alert sounds with a variety of characteristics (e.g., different volume levels, frequencies, durations) in a variety of environmental conditions (e.g., the environment sound 116 from different environment sound sources 118). Empirical derivations may further include receiving the audio signal 120, which is generated under the variety of different controlled circumstances mentioned above. Empirical derivations may further include generating the acoustic sound audio data 214 using the audio signal 120. Empirical derivations may further include determining a score using the acoustic sound audio data 214. The score can be determined to have a value in a range of numerical values. For example, a first score for a chime alert being played with no ambient noise in the vehicle 130 may be determined to have a numerical value of 95 in a range of 0 to 100. In another example, a second score for the chime alert being played while music is being played in the vehicle 130 may be determined to have a numerical value of 75 in the range of 0 to 100. In yet another example, a third score for the chime alert being played while an emergency vehicle siren is played near the vehicle 130 may be determined to have a numerical value of 40 in the range of 0 to 100. The threshold 224 may be a threshold value determined using the range of numerical values. For example, the threshold 224 may be a threshold value of 70 of which values above 70 represent the occupant 132 hearing the alert sound 104 and values below 70 represent the occupant 132 unlikely hearing the alert sound 104. The above numerical values are merely examples and any other numerical values and/or ranges of numerical values are contemplated. Alternatively, the score 218 and/or the threshold 224 may have a different representation, such as a percentage.

The threshold 224 is shown to be stored in a datastore. For example, the datastore may be implemented by computer memory and/or one or more mass storage devices. Alternatively, the audible alert detection system 102 may dynamically generate the threshold 224.

If, during the processing operations 222, the audible alert detection system 102 determines that the score 218 meets and/or exceeds the threshold 224 and thereby satisfies the threshold 224, the audible alert detection system 102 determines that the occupant 132 perceives the alert sound 104 as an alert (e.g., a warning). If, during the processing operations 222, the audible alert detection system 102 determines that the score 218 falls below the threshold 224 and thereby does not satisfy the threshold 224, the audible alert detection system 102 escalates the alert action because the occupant 132 did not perceive the alert sound 104 as an alert (e.g., a warning). For example, when the score 218 falls below the threshold 224, the audible alert detection system 102 can detect a safety concern with the generation of the alert sound 104. In some aspect, the audible alert detection system 102 may output a signal (e.g., an alert signal) to another system of the vehicle 130 to cause the vehicle 130 to generate an alert to gain attention of the occupant 132 when the score 218 indicates the alert sound 104 is not perceptible to the occupant 132 as an alert.

In some embodiments, the safety concern may be a presence of a fault condition with the audio output device 108 such that the audio output device 108 is unable to output the alert sound 104. In another example, the safety concern may indicate that the audio output device 108 did output the alert sound 104 but output the alert sound 104 with insufficient power and/or clarity for a person in the environment 200 to hear. In yet another example, the safety concern may be a presence of a fault condition with one or more components shown in FIG. 2, such as the alert sound playback controller 202, the audio rendering software 206, the DAC 210, the audio sensor 114, the ADC 212, and/or portion(s) of the audible alert detection system 102 are nonoperational.

In some embodiments, in response to detecting a safety concern associated with the generation of the alert sound 104, one or more alert actions may be performed because the alert sound 104 is not perceptible to the occupant 132 as an alert. Assume for example the environment 200 in FIG. 2 is the vehicle 130 of FIG. 1B and the audible alert detection system 102 detected a safety concern because the alert sound 104 is not perceptible to the occupant 132. In such an example, the audible alert detection system 102 may execute one or more escalatory alert actions for attracting the attention of the occupant 132. For example, the audible alert detection system 102 may cause the alert sound playback controller 202 to replay the alert sound 104. In another example, the audible alert detection system 102 may cause the alert sound playback controller 202 to increase a volume of the alert sound 104 or play a different alert sound to attract the attention of the occupant 132.

In yet another example, the audible alert detection system 102 may output a visual alert for display to the occupant 132 on one or more display devices of the vehicle 130. An example of the visual alert is one or more graphics, such as visual graphics. For example, the graphic may be a graphical object, such as an icon, a symbol, and/or associated text. Examples of the display device(s) include a touchscreen display on the console 142, a heads-up display in the windshield, and an instrument panel behind the steering wheel.

Additionally or alternatively to the visual alert, the audible alert detection system 102 may output a haptic alert to gain the attention of the occupant 132. For example, the audible alert detection system 102 may cause the seat 138A and/or the headrest 140A of the driver to provide haptic feedback (e.g., vibrate) according to a predefined haptic alert profile.

An example of a predefined haptic alert profile includes a vibration frequency, a type of vibration frequency (e.g., harmonic vibration, random vibration), and/or a specified duration of the vibration frequency. In such an example, the occupant 132 may understand that the vehicle 130 is to perform a particular operation, such as transitioning from autonomous mode to manual mode, in response to feeling the haptic alert.

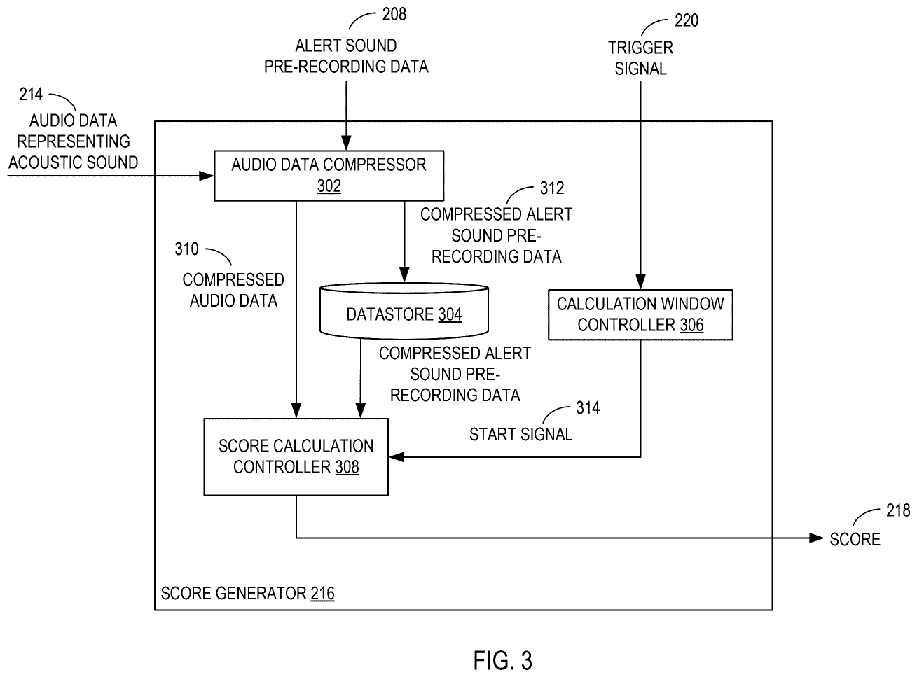

FIG. 3 depicts an example implementation of the score generator 216 of FIG. 2. The score generator 216 of the shown example includes an audio data compressor 302, a datastore 304, a calculation window controller 306, and a score calculation controller 308.

In the illustrated example, the audio data compressor 302 is configured to compress audio data using one or more audio data compression techniques. In an example operation, the audio data compressor 302 receives the acoustic sound audio data 214 and the alert sound audio data 208. The audio data compressor 302 executes audio data compression technique(s) on the acoustic sound audio data 214 to generate compressed audio data 310. In some embodiments, the audio data compressor 302 compresses the sampling rate of the acoustic sound audio data 214 and the alert sound audio data 208 from 48 kHz to 2 kHz (or lower). An example audio data compression technique includes using one or more low-pass filters followed by decimation.

The audio data compressor 302 is shown to execute audio data compression technique(s) on the alert sound audio data 208 to generate compressed alert sound audio data 312. For example, the alert sound audio data 208 may be reference audio data representing a pre-recording of the alert sound 104. The reference audio data may have a first sampling rate. The first sampling rate may be a sampling rate before audio data compression. The audio data compressor 302 may compress the reference audio data such that the first sampling rate (e.g., a high sampling rate) is reduced to a second sampling rate (e.g., a low sampling rate). The second sampling rate may be a sampling rate after audio data compression.

The audio data compressor 302 stores the compressed alert sound audio data 312 in the datastore 304. For example, the compressed alert sound audio data 312 may be compressed reference audio data. Beneficially, the audio data compressor 302 can compress the alert sound audio data 208 in advance such as prior to deploying the audible alert detection system 102 for audible alert detection in the vehicle 130. By compressing the alert sound audio data 208 in advance, the score generator 216 can reduce processing latency of the score generator 216 and/or, more generally, the audible alert detection system 102, when determining the score 218 for detecting audibility of the alert sound 104. For example, the score generator 216 can retrieve the compressed alert sound audio data 312 from the datastore 304 for processing, which consumes less time than compressing the alert sound audio data 208 every time the compressed alert sound audio data 312 is needed.

In some embodiments, the datastore 304 can be implemented by any technology for storing data. For example, the datastore 304 can be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The datastore 304 may additionally or alternatively be implemented by one or more double data rate (DDR) memories, such as DDR, DDR2, DDR3, DDR4, DDR5, mobile DDR (mDDR), etc. The datastore 304 may additionally or alternatively be implemented by one or more mass storage devices such as hard disk drive(s) (HDD(s)), solid-state disk (SSD) drive(s), etc. While in the illustrated example the datastore 304 is illustrated as a single datastore, the datastore 304 may be implemented by any number and/or type(s) of datastore. Furthermore, the data stored in the datastore 304 may be in any data format. Examples of data formats include a flat file, binary data, and audio data. Examples of audio data formats include MP3, AAC, and Ogg Vorbis.

The score calculation controller 308 is shown to determine, generate, and/or output the score 218 using one or more of a plurality of inputs. A first input is the compressed audio data 310. A second input is the compressed alert sound audio data 312, which can be retrieved from the datastore 304. A third input is a start signal 314 from the calculation window controller 306.

The calculation window controller 306 is depicted as generating and/or outputting the start signal 314 in response to the trigger signal 220. The trigger signal 220 is generated to trigger a start of a time window in which the alert sound 104 is expected to be audible to the occupant 132 of the vehicle 130. The trigger signal 220 is generated to reduce consumption of processing resources by the score generator 216 because the score generator 216 may process the acoustic sound audio data 214 when the trigger signal 220 is received and may not process the acoustic sound audio data 214 otherwise. Additionally, the trigger signal 220 may be generated to provide advance notification to the score generator 216 to process the acoustic sound audio data 214 due to a latency time gap between generation of the alert sound start command 204 and the output of the alert sound 104.

In the shown example, the calculation window controller 306 is configured to begin, initialize, and/or trigger a start of a time window (e.g., a calculation window) in which the score 218 is to be determined in response to receiving the trigger signal 220. The calculation window controller 306 can output the start signal 314 to cause the score calculation controller 308 to begin processing the compressed audio data 310 and the compressed alert sound audio data 312 for determination of the score 218. Beneficially, the start signal 314 can be used to avoid and/or reduce the likelihood of false positive confirmations outside the calculation window because the score calculation controller 308 may generate the score 218 for the time window and may not generate the score 218 outside the time window.

The score calculation controller 308 can determine the score 218 by executing and/or performing cross-correlation (or cross correlation) using the compressed audio data 310 and the compressed alert sound audio data 312. The volume of the acoustic sound 112 heard by the microphone 114 may be adjusted to sit within a desired and acceptable range.

The score calculation controller 308 can use cross-correlation (also known as “sliding dot product” or “sliding inner-product”) to measure the similarity between a first signal (e.g., the acoustic sound 112) represented by the compressed audio data 310 and a second signal (e.g., a chime signal) represented by the compressed alert sound audio data 312. For example, the score calculation controller 308 may use cross-correlation to slide the second signal over the first signal and compute a measure of similarity at each position in time. The calculated correlation value (also known as “correlation coefficient”) may be adjusted or normalized according to the volume of the received signal.

The score calculation controller 308 may determine a correlation coefficient of the first and second signals in a range from −1.0 to +1.0. The score calculation controller 308 may determine that the first and second signals are more closely identical when the correlation coefficient is closer to +1.0. The score calculation controller 308 may determine that the first and second signals are less similar when the correlation coefficient is closer to −1.0. Different ranges of correlation coefficient values may be used (e.g., −0.5 to +0.5, −2.0 to +2.0). Additionally or alternatively, the score calculation controller 308 may use a cosine similarity technique, a Euclidean distance technique, Dynamic Time Warping (DTW), Pearson correlation, and/or machine learning techniques to determine the similarities between the compressed audio data 310 and the compressed alert sound audio data 312.

The score calculation controller 308 may determine the score 218 using the correlation coefficient. In some embodiments, the score calculation controller 308 may convert the range of correlation coefficients into a range of the score 218 using a linear scale. For example, the score calculation controller 308 may scale a correlation coefficient range of −1.0 to +1.0 to a score range of 0 to 100. In such an example, the score calculation controller 308 may convert a correlation coefficient of −1.0 to a score of 0 (e.g., the score 218 is 0). In another example, the score calculation controller 308 may convert a correlation coefficient of 0 to a score of 50 (e.g., the score 218 is 50). In yet another example, the score calculation controller 308 may convert a correlation coefficient of +1.0 to a score of 100 (e.g., the score 218 is 100).

In some embodiments, the score generator 216 may be used to assess audibility of different types of alert sounds in different environments and/or under different environment conditions. By assessing audibility of different types of alert sounds under a variety of circumstances, an alert sound may be selected to increase a likelihood of the occupant 132 hearing the alert sound. Beneficially, by selecting a type of alert sound using the audibility assessments, the occupant 132 can have an increased likelihood of hearing the alert sound under various circumstances such that the occupant 132 can perceive the notification, warning, etc., conveyed by the alert sound in such circumstances.

By way of example, the acoustic sound audio data 214 may represent different alert sounds subjected to different environment conditions. The score generator 216 may determine (e.g., iteratively determine) the score 218 for a plurality of samples. Examples of samples include a chime, a chirp, a ding, and a ring in various controlled sets of environment conditions. Examples of controlled sets of environment conditions include no ambient noise in the vehicle 130, music played at a specified decibel level external to the vehicle 130, an emergency vehicle siren at a specified distance from the vehicle 130, and wind noise at a specified speed.

The score generator 216 and/or, more generally, the audible alert detection system 102, may identify which of the different alert sounds (e.g., chime, chirp, ding, ring) had the highest score for the different controlled sets of environment conditions. Using the scores, a type of alert sound may be chosen for a particular application. For example, using the scores, a chime may be selected for alerting the occupant 132 that the vehicle 130 is transitioning from the autonomous mode to the manual mode. In another example, using the scores, a ring may be selected for alerting the occupant 132 that another vehicle is in a blind spot of the occupant 132. In such an example, a ring may have a first score greater than a second score in a noisy environment for the chime and the ring can thereby have a higher likelihood to convey the warning to the occupant 132 of a safety concern. In yet another example, using the scores, a chirp may be selected for alerting the occupant 132 that a fluid level, such as windshield cleaning fluid, is at a low level. In such an example, a chirp may have a third score less than the first and second scores and the chirp can thereby be used to convey a notification with less severity than warning about changing from autonomous to manual mode or a vehicle in a blind spot of the occupant 132.

In some embodiments, the score generator 216 may use the scores to empirically determine the threshold 224. For example, a numerical value of 70 for the threshold 224 may be empirically derived using scores for different alert sounds as described in further detail below. Empirical derivations may include configuring an alert sound with a pre-selected set of characteristics, such as a particular volume level, frequency, and/or duration. For example, the alert sound audio data 208 can be generated that, when rendered into audio, is a ring alert having a specified volume level, frequency, and/or duration.

By way of example for using scores to empirically determine the threshold 224, the pre-recording of alert sound audio data 208 can be provided to the audio data compressor 302, which is within the score generator 216 (as shown in FIG. 3), and output to the audio rendering software 206 (as shown in FIG. 2) for playback by the speaker 108 under certain environmental conditions, such as no ambient noise in the vehicle 130. Responsive to playing the chime alert (e.g., the alert sound 104 as shown in FIGS. 1A-1B), the audio signal 120 that includes the chime alert and the environment sound 116 in the digital form (e.g., the acoustic sound audio data 214) is received by the score generator 216.

Furthering the example for using scores to empirically determine the threshold 224, the score generator 216 can generate a score by comparing the compressed acoustic sound audio data 214 (e.g., the compressed audio data 310) and the compressed alert sound pre-recording data. The score for the chime alert with no ambient noise in the vehicle 130 can be determined to have a numerical value of 100 or close to 100 in a range of 0 to 100.

Furthering the example for using scores to empirically determine the threshold 224, in the same environmental conditions of no ambient noise, the audible alert detection system 102 may output (e.g., iteratively output) different alert sounds, such as a chirp, a ding, and a ring; receive the acoustic sound audio data 214 that results from the output of the different alert sounds; determine a score for each of the different alert sounds using the received acoustic sound audio data 214; and determine the score to have respective numerical values in the range of 0 to 100. For example, the audible alert detection system 102 may output a chirp in the vehicle 130 with no ambient noise and determine a score of 95, a ding in the vehicle 130 with no ambient noise and determine a score of 93, and so forth. Such values of scores are merely examples and the disclosure is not so limited.

Furthering the example for using scores to empirically determine the threshold 224, the audible alert detection system 102 may output (e.g., iteratively output) the different alert sounds, such as the chime, the chirp, the ding, and the ring for a different set of environmental conditions, such as music being played at a particular decibel level in the vehicle 130, for characterizations thereof. A plurality of scores under the different set of environmental conditions can thereby be generated. A different set of environmental conditions may be music being played in the vehicle 130 at 75 decibels (dB). Under such example environmental conditions, the audible alert detection system 102 may sequentially output a chime, a chirp, and a ding in the vehicle 130. The audible alert detection system 102 may determine a score of 70 for the chime, a score of 60 for the chirp, and a score of 65 for the ding. Such values of scores are merely examples and the disclosure is not so limited.

In some aspects, the threshold 224 may be a numerical value (e.g., 60) of which a score 218 matching or above this numerical value represents the occupant 132 will hear the alert sound 104 and a score 218 below this numerical value represents the occupant 132 will not hear the alert sound 104 under different controlled sets of environment conditions. The threshold 224 and the above numerical values are merely examples and any other numerical values and/or ranges of numerical values are contemplated. In some other aspects, the score 218 and/or the threshold 224 may have a different representation, where the threshold 224 may be a certain percentage, and the score 218 may also be in the form of a percentage that represents the likelihood of the occupant 132 hearing the alert sound 104 under different controlled sets of environment conditions.

Furthering the example for using scores to empirically determine the threshold 224, the audible alert detection system 102 may use the scores 100, 95, 93 for the environmental conditions of no ambient noise and the scores 70, 60, and 65 for the environmental conditions of noise (e.g., music being played) at 75 dB to determine the threshold 224. For example, the audible alert detection system 102 may determine the threshold 224 as the floor of the values. In such an example, the audible alert detection system 102 may determine the threshold 224 to be 60, which is the floor of the values of 100, 95, 93, 70, 60, and 65. In another example, the audible alert detection system 102 may determine the threshold 224 as the median of the values. In such an example, the audible alert detection system 102 may determine the threshold 224 to be 81.5, which is the median of the values. Alternatively, the audible alert detection system 102 may determine the threshold 224 as the average of the values.

While an example implementation of the score generator 216 of FIG. 2 is depicted in FIG. 3, other implementations are contemplated. For example, one or more blocks, components, functions, etc., of the score generator 216 may be combined or divided in any other way. The score generator 216 of the illustrated example may be implemented by hardware alone, or by a combination of hardware, software, and/or firmware. For example, the score generator 216 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), graphics processing units (GPUs), etc.), one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

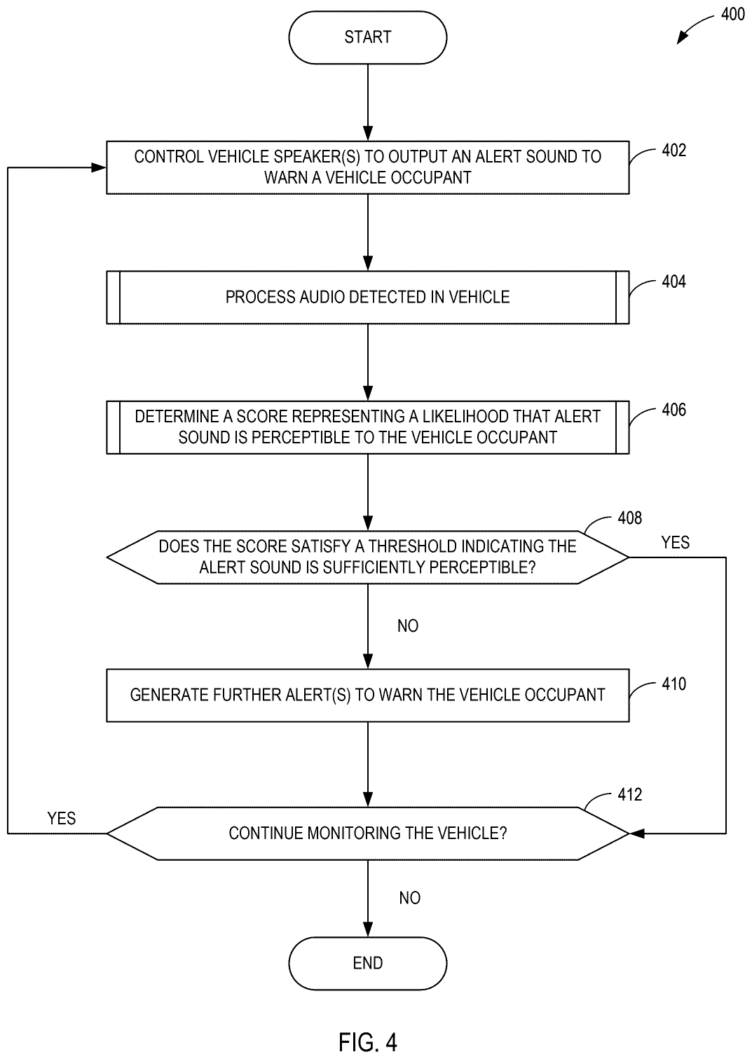

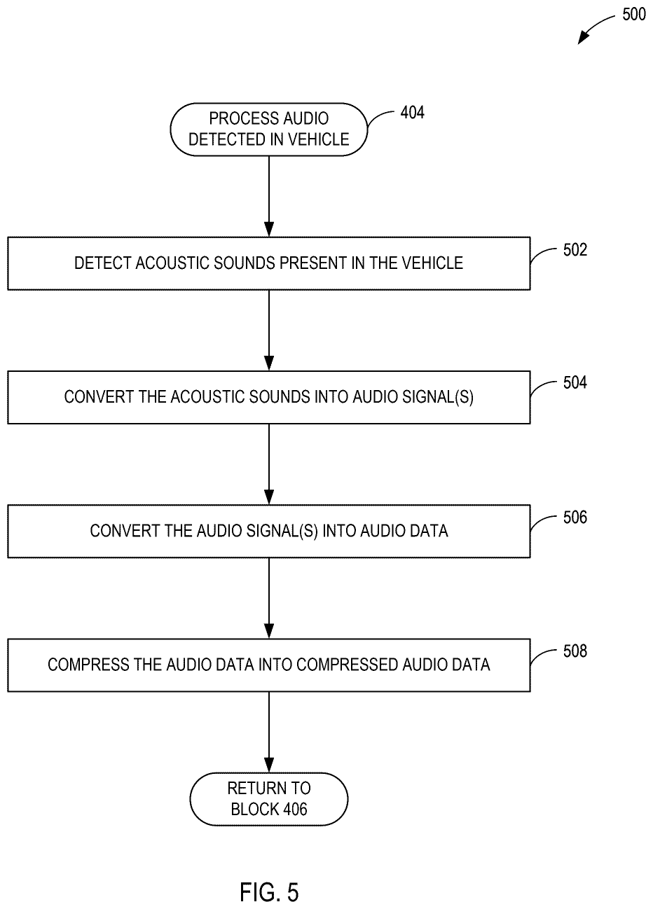

FIGS. 4-6 are flowcharts representative of example processes to be performed to determine a perceptibility of an alert sound as an alert in a vehicle, such as the vehicle 130 of FIG. 1B. In some embodiments, FIGS. 4-6 are flowcharts representative of example processes to implement the score generator 216 of FIGS. 2 and/or 3 to determine a perceptibility of an alert sound as an alert in a vehicle, such as the vehicle 130 of FIG. 1B. In some other embodiments, FIGS. 4-6 are flowcharts representative of example processes to implement the audible alert detection system 102 of FIGS. 1A, 1B, and/or 2 to determine a perceptibility of an alert sound as an alert in a vehicle, such as the vehicle 130 of FIG. 1B. Additionally or alternatively, block(s) of one(s) of the flowcharts of FIGS. 4, 5, and/or 6 may be representative of state(s) of one or more hardware-implemented state machines, algorithm(s) that may be implemented by hardware alone such as an ASIC, etc., and/or any combination(s) thereof.

FIG. 4 is a flowchart 400 representative of an example process that may be performed to determine a perceptibility of an alert sound as an alert in a vehicle, such as the vehicle 130 of FIG. 1B. The flowchart 400 of FIG. 4 begins at block 402, at which the audible alert detection system 102 may control vehicle speaker(s) to output an alert sound to warn a vehicle occupant. Specifically, the alert sound playback controller 202 may output the alert sound start command 204 to the audio rendering software 206 and the trigger signal 220 to the score generator 216. The audio rendering software 206 may output the alert sound pre-recording data 208 to the DAC 210 in response to receiving the alert sound start command 204. Upon receiving the alert sound pre-recording audio data 208, the DAC 210 converts the alert sound pre-recording audio data 208 into the alert sound signal 110, which is then outputted to the speaker 108 in the vehicle 130, thereby controlling audible output of the alert sound 104 and outputting the alert sound 104 in the time window triggered by the trigger signal 220.

At block 404, the audible alert detection system 102 may process audio detected in vehicle. Specifically, the audio sensor 114 may output the acoustic sound 112 as the audio signal 120. The acoustic sound 112 may include a plurality of acoustic sounds present in the vehicle 130. The ADC 212 may convert the audio signal 120 into the acoustic sound audio data 214. An example process that may be performed to implement block 404 is described below in connection with FIG. 5.

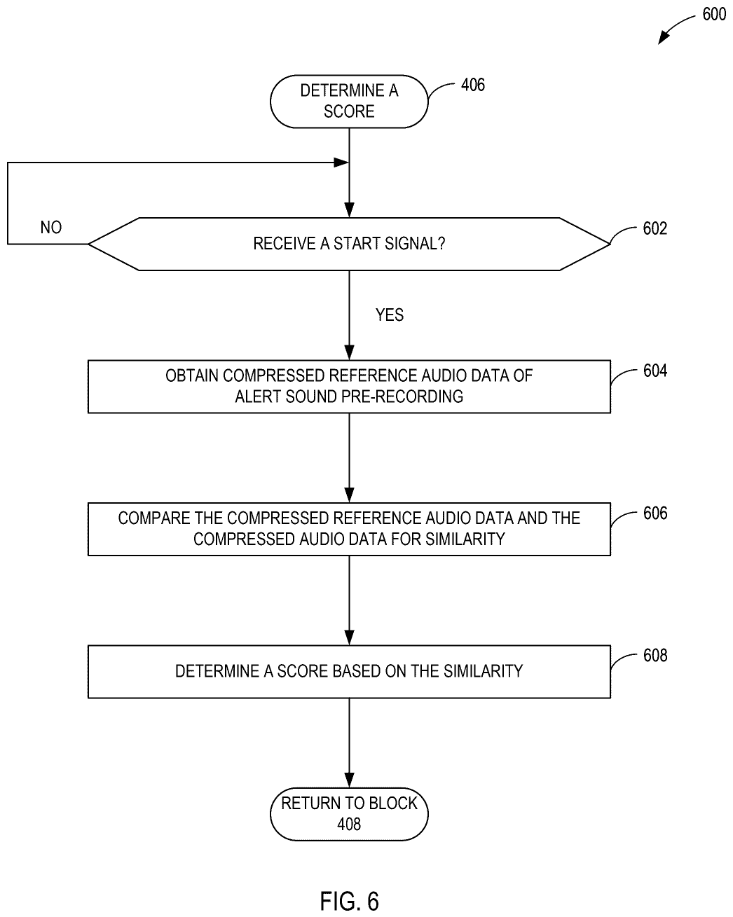

At block 406, the audible alert detection system 102 may determine a score representing a likelihood that alert sound is perceptible to the vehicle occupant. Specifically, the audio data compressor 302 may compress the acoustic sound audio data 214 into the compressed audio data 310. The score calculation controller 308 may compare the compressed audio data 310 and the compressed alert sound pre-recording data shown in FIG. 3. The score calculation controller 308 may generate the score 218 based on the comparison. For example, the score calculation controller 308 may generate the score 218 to have a greater value (e.g., 93, 95, 100) when the similarity of the compressed audio data 310 and the compressed alert sound pre-recording data is greater (e.g., +0.8, +0.9, +1.0 for a correlation coefficient range of −1.0 to +1.0) when compared to the compressed audio data 310 and the compressed alert sound pre-recording data not being similar (e.g., −1.0, −0.9, −0.8 for a correlation coefficient range of −1.0 to +1.0). In such an example, the score calculation controller 308 may determine that the similarity of the compressed audio data 310 and the compressed alert sound pre-recording data corresponds to a correlation coefficient of +0.9. The score calculation controller 308 may convert the correlation coefficient of +0.9 to a score of 95 using linear scaling. An example process that may be performed to implement block 406 is described below in connection with FIG. 6.

At block 408, the audible alert detection system 102 may determine whether the score satisfies a threshold indicating the alert sound is sufficiently perceptible. Specifically, the audible alert detection system 102 may compare the score 218 and the threshold 224.

If, the audible alert detection system 102 determines that the score 218 meets and/or exceeds the threshold 224 and thereby satisfies the threshold 224, control proceeds to block 412 because the audible alert detection system 102 determines that there is a relatively high likelihood that the occupant 132 perceived the alert sound 104 as an alert. For example, the score 218 meeting and/or exceeding the threshold 224 can indicate that the alert sound 104 is detected in the acoustic sound 112 and is sufficiently audible to the occupant 132 such that the occupant 132 likely perceived the alert sound 104 as an alert.

If, the audible alert detection system 102 determines that the score 218 falls below the threshold 224 and thereby does not satisfy the threshold 224, control proceeds to block 410 because the audible alert detection system 102 determines that there is not a relatively high likelihood that the occupant 132 perceived the alert sound 104 as an alert. For example, the score 218 falling below the threshold 224 can indicate that the alert sound 104 is not detected in the acoustic sound 112 and/or is not sufficiently audible to the occupant 132 such that the occupant 132 likely did not perceive the alert sound 104 as an alert.

At block 410, the audible alert detection system 102 may generate further alert(s) to warn the vehicle occupant. Specifically, by determining that the score 218 falls below the threshold 224, the audible alert detection system 102 determines that the occupant 132 likely did not perceive the alert sound 104 as an alert. To mitigate the potential safety concern that the occupant 132 was not warned, the audible alert detection system 102 may generate one or more further alerts to warn the occupant 132. The audible alert detection system 102 may generate such further alert(s) by causing the seat of the occupant 132 to vibrate, the steering wheel to vibrate, display an alert on touchscreen(s), etc., and/or any combination(s) thereof to gain the attention of the occupant 132.

At block 412, the audible alert detection system 102 may determine whether to continue monitoring the vehicle. Specifically, the audible alert detection system 102 may determine to continue monitoring for perceptibility of further ones of the alert sound 104 in the vehicle 130. If, at block 412, the audible alert detection system 102 determines to continue monitoring the vehicle, control returns to block 402. Otherwise, the example flowchart 400 of FIG. 4 concludes.

FIG. 5 is a flowchart 500 representative of an example process that may be performed to determine to process audio detected in a vehicle, such as the vehicle 130 of FIG. 1B. In some embodiments, the flowchart 500 may be performed and/or executed to implement block 404 of FIG. 4.

The flowchart 500 of FIG. 5 begins at block 502, at which the audible alert detection system 102 may detect acoustic sounds present in the vehicle. Specifically, the audio sensor 114 may detect the acoustic sound 112 present in the vehicle 130. The acoustic sound 112 may include the alert sound 104.

At block 504, the audible alert detection system 102 may convert the acoustic sounds into audio signal(s). Specifically, the audio sensor 114 may convert the detected acoustic sound 112 into the audio signal 120. The audio sensor 114 may output the audio signal 120 to the ADC 212.

At block 506, the audible alert detection system 102 may convert the audio signal(s) into audio data. Specifically, the ADC 212 convert the audio signal 120 into the acoustic sound audio data 214 in response to receiving the audio signal 120 from the audio sensor 114. The ADC 212 may output the acoustic sound audio data 214 to the audio data compressor 302, which is included in the score generator 216.

At block 508, the audible alert detection system 102 may compress the audio data into compressed audio data. Specifically, the audio data compressor 302 may compress the acoustic sound audio data 214 into the compressed audio data 310. The audio data compressor 302 may output the compressed audio data 310 to the score calculation controller 308 for determination of the score 218.

After compressing the audio data into compressed audio data at block 508, the flowchart 500 of FIG. 5 concludes. The flowchart 500 may return to block 406 of the flowchart 400 of FIG. 4.

FIG. 6 is a flowchart 600 representative of an example process that may be performed to determine a score indicative of the perceptibility of an alert sound as an alert to an occupant in a vehicle, such as the vehicle 130 of FIG. 1B. In some embodiments, the flowchart 600 may be performed and/or executed to implement block 406 of FIG. 4.

The flowchart 600 of FIG. 6 begins at block 602, at which the audible alert detection system 102 may determine whether a start signal is received. Specifically, the score calculation controller 308 may determine whether the start signal 314 is received. The calculation window controller 306 may output the start signal 314 in response to receiving the trigger signal 220 from the alert sound playback controller 202. The trigger signal 220 is generated by the alert sound playback controller 202 when the alert sound 104 is to be output by the speaker 108. The trigger signal 220 indicates the start of a time window in which the alert sound 104 is expected to be output by the speaker 108.

If, at block 602, the audible alert detection system 102 determines that a start signal is not received, control waits at block 602 until a start signal is received. In some embodiments, the flowchart 600 of FIG. 6 may conclude if the start signal is not received after a period of time has elapsed (e.g., 5 seconds, 10 seconds, 30 seconds, 1 minute, etc.). Otherwise, control proceeds to block 604.

At block 604, the audible alert detection system 102 may obtain compressed reference audio data of an alert sound pre-recording. Specifically, the score calculation controller 308 may receive the compressed alert sound audio data 312 from the datastore 304. The datastore 304 may receive the compressed alert sound audio data 312 from the audio data compressor 302. The audio data compressor 302 may generate the compressed alert sound audio data 312 by compressing the alert sound audio data 208, which the audio data compressor 302 receives from the datastore shown in FIG. 2 that stores the alert sound audio data 208.

At block 606, the audible alert detection system 102 may compare the compressed reference audio data and the compressed audio data for similarity. Specifically, the score calculation controller 308 may perform cross-correlation to measure a similarity between a first signal (e.g., the acoustic sound 112) represented by the compressed audio data 310 and a second signal (e.g., a chime signal) represented by the compressed alert sound audio data 312. During cross-correlation, the score calculation controller 308 may slide the second signal over the first signal and compute a measure of similarity at each position in time. The calculated correlation value may be adjusted or normalized according to the volume of the received signal. The score calculation controller 308 may determine a correlation coefficient of the first and second signals in a range from −1.0 to +1.0. The score calculation controller 308 may determine that the first and second signals are more closely identical when the correlation coefficient is closer to +1.0. Different ranges of correlation coefficient values may be used (e.g., −0.5 to +0.5, −2.0 to +2.0).

At block 608, the audible alert detection system 102 may determine a score based on the similarity. Specifically, the score calculation controller 308 may determine the calculated correlation value as the score 218.

After determining a score based on the similarity at block 608, the flowchart 600 of FIG. 6 concludes. The flowchart 600 may return to block 408 of the flowchart 400 of FIG. 4.

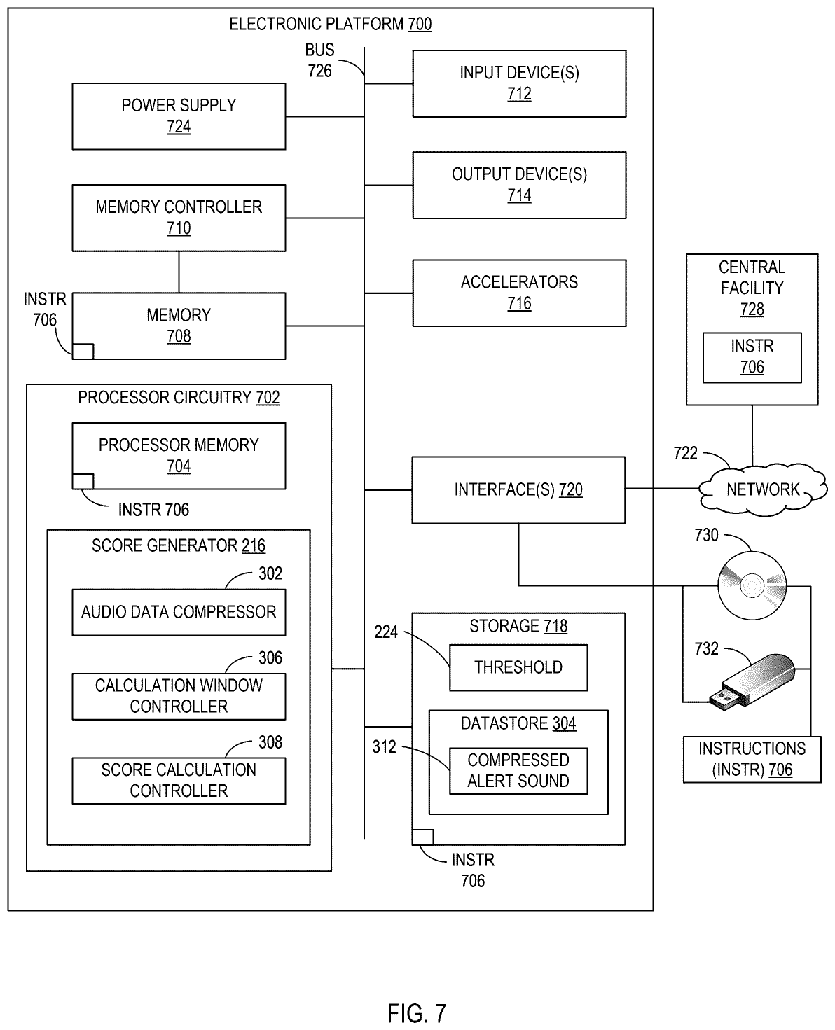

FIG. 7 is an example implementation of an electronic platform 700 structured to execute the machine-readable instructions of FIGS. 4, 5, and/or 6 to implement audible alert detection system 102, or portion(s) thereof. It should be appreciated that FIG. 7 is intended neither to be a description of necessary components for an electronic and/or computing device to operate as the audible alert detection system 102, in accordance with the techniques described herein, nor a comprehensive depiction.

In some embodiments, the electronic platform 700 is the vehicle 130 of FIGS. 1B and/or 2. In some embodiments, the electronic platform 700 is one or more components of the vehicle 130. For example, the electronic platform 700 may be an electronic device, such as an electronic device in a vehicle console, a vehicle ECU, a system-on-a-chip (SoC), or any other type of computing and/or electronic device.

The electronic platform 700 of the illustrated example includes processor circuitry 702, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 702 includes processor memory 704, which may be volatile memory, such as random-access memory (RAM) of any type. The processor circuitry 702 of this example implements the score generator 216, the audio data compressor 302, the calculation window controller 306, and the score calculation controller 308 of FIGS. 2 and/or 3. Additionally or alternatively, the processor circuitry 702 may implement the processing operations 222 of FIG. 2.

The processor circuitry 702 may execute machine-readable instructions 706 (identified by INSTRUCTIONS), which are stored in the processor memory 704, to implement at least one of the score generator 216, the audio data compressor 302, the calculation window controller 306, and/or the score calculation controller 308 of FIGS. 2 and/or 3. The machine-readable instructions 706 may include data representative of computer-executable and/or machine-executable instructions implementing techniques that operate according to the techniques described herein. For example, the machine-readable instructions 706 may include data (e.g., code, embedded software (e.g., firmware), software, etc.) representative of the flowcharts of FIGS. 4, 5, and/or 6, or portion(s) thereof.

The electronic platform 700 includes memory 708, which may include the instructions 706. The memory 708 of this example may be controlled by a memory controller 710. For example, the memory controller 710 may control reads, writes, and/or, more generally, access(es) to the memory 708 by other component(s) of the electronic platform 700. The memory 708 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 700 includes input device(s) 712 to enable data and/or commands to be entered into the processor circuitry 702. For example, the input device(s) 712 may include an audio sensor, a camera (e.g., a still camera, a video camera, etc.), a light detection and ranging (LIDAR) sensor, a microphone, a touchscreen, a voice recognition system, etc., and/or any combination(s) thereof. For example, the input device(s) 712 may implement the audio sensor 114 of FIGS. 1A and/or 2 and/or one(s) of the microphones 114A, 114B, 114C, 114D of FIG. 1B.

The electronic platform 700 includes output device(s) 714 to convey, display, and/or present information to a user, such as a vehicle occupant. For example, the output device(s) 714 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 714 can be used, among other things, to generate, launch, and/or present a user interface. For example, the user interface may be generated and/or implemented by the output device(s) 714 for visual presentation of output and speakers or other sound generating devices for audible presentation of output. In such an example, the output device(s) 714 may implement the audio output device 108 of FIGS. 1A and/or 2 and/or one(s) of the speakers 108A, 108B, 108C, 108D of FIG. 1B.

The electronic platform 700 includes accelerators 716, which are hardware devices to which the processor circuitry 702 may offload compute tasks to accelerate their processing. For example, the accelerators 716 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the score generator 216, the audio data compressor 302, the calculation window controller 306, and/or the score calculation controller 308 may be implemented by one(s) of the accelerators 716 instead of the processor circuitry 702. In some examples, the score generator 216, the audio data compressor 302, the calculation window controller 306, and/or the score calculation controller 308 may be executed concurrently (e.g., in parallel, substantially in parallel, etc.) by the processor circuitry 702 and the accelerators 716. For example, the processor circuitry 702 and one(s) of the accelerators 716 may execute in parallel function(s) corresponding to the audio data compressor 302.

The electronic platform 700 includes storage 718 to record and/or control access to data, such as the machine-readable instructions 706. In this example, the storage 718 implements the threshold 224, the datastore 304, and the compressed alert sound audio data 312. The storage 718 may be implemented by one or more mass storage disks or devices, such as HDDs, SSDs, etc., and/or any combination(s) thereof.

The electronic platform 700 includes interface(s) 720 to effectuate exchange of data with external devices (e.g., computing and/or electronic devices of any kind) via a network 722. The interface(s) 720 of the illustrated example may be implemented by an interface device, such as network interface circuitry (e.g., a NIC, a smart NIC, etc.), a gateway, a router, a switch, etc., and/or any combination(s) thereof. The interface(s) 720 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 700 includes a power supply 724 to store energy and provide power to components of the electronic platform 700. The power supply 724 may be implemented by a power converter, such as an alternating current-to-direct-current (AC/DC) power converter, a direct current-to-direct current (DC/DC) power converter, etc., and/or any combination(s) thereof. For example, the power supply 724 may be powered by an external power source, such as an alternating current (AC) power source (e.g., an electrical grid), a direct current (DC) power source (e.g., a battery, a battery backup system, etc.), etc., and the power supply 724 may convert the AC input or the DC input into a suitable voltage for use by the electronic platform 700. In some examples, the power supply 724 may be a limited duration power source, such as a battery (e.g., a rechargeable battery such as a lithium-ion battery).

Component(s) of the electronic platform 700 may be in communication with one(s) of each other via a bus 726. For example, the processor circuitry 702 may be communicatively coupled to at least one storage medium (e.g., the memory 708, the storage 718) via the bus 726. The bus 726 may be any type of computing and/or electrical bus, such as an I2C bus, a PCI bus, a PCIe bus, a SPI bus, audio bus, and/or the like.

The network 722 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 722 may be the Internet, but any other type of private and/or public network is contemplated.

The network 722 of the illustrated example facilitates communication between the interface(s) 720 and a central facility 728. The central facility 728 in this example may be an entity associated with one or more servers, such as one or more physical hardware servers and/or virtualizations of the one or more physical hardware servers. For example, the central facility 728 may be implemented by a public cloud provider, a private cloud provider, etc., and/or any combination(s) thereof. In this example, the central facility 728 may compile, generate, update, etc., the machine-readable instructions 706 and store the machine-readable instructions 706 for access (e.g., download) via the network 722. For example, the electronic platform 700 may transmit a request, via the interface(s) 720, to the central facility 728 for the machine-readable instructions 706 and receive the machine-readable instructions 706 from the central facility 728 via the network 722 in response to the request.

Additionally or alternatively, the interface(s) 720 may receive the machine-readable instructions 706 via non-transitory machine-readable storage media, such as an optical disc 730 (e.g., a Blu-ray disc, a CD, a DVD, etc.) or any other type of removable non-transitory machine-readable storage media such as a USB drive 732. For example, the optical disc 730 and/or the USB drive 732 may store the machine-readable instructions 706 thereon and provide the machine-readable instructions 706 to the electronic platform 700 via the interface(s) 720.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single-or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single-or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions (e.g., processor-executable instructions) implementing the techniques described herein (when implemented as one or more functional facilities or in any other manner) may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner. As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A,,and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly. the foregoing description and drawings are by way of example only.

What is claimed is:

1. A system for alert detection in a vehicle, comprising:
at least one storage medium storing processor-executable instructions; and
at least one processor communicatively coupled to the at least one storage medium and, when the at least one processor executes the processor-executable instructions, causes the system to:
trigger a start of a time window in which an alert sound is expected to be perceived by an occupant of the vehicle as a warning to the occupant;
generate a signal to output the alert sound in the vehicle and in the time window;
receive audio data representing a plurality of acoustic sounds present in the vehicle and in the time window;
determine, using the received audio data, a score representing a likelihood the occupant perceived the alert sound as the warning; and
cause generation of an alert to gain attention of the occupant when the score indicates the occupant did not perceive the alert sound as the warning.

2. The system of claim 1, wherein execution of the instructions causes the system to generate the alert by causing a graphic to be displayed on a graphical user interface in the vehicle.

3. The system of claim 1, wherein the alert sound is a first alert sound, and execution of the instructions further causes the system to generate the alert by outputting a second alert sound of a different type than the first alert sound.

4. The system of claim 1, wherein execution of the instructions further causes the system to generate the alert by providing haptic feedback to the occupant.

5. The system of claim 4, wherein execution of the instructions further causes the system to provide haptic feedback to the occupant by vibrating, in the vehicle, at least one of a steering wheel or one or more vehicle seats.

6. The system of claim 1, wherein execution of the instructions further causes the system to determine the score by:
obtaining reference audio data representative of a recording of the alert sound;
comparing the reference audio data and the received audio data for similarity; and
determining the score based on the similarity of the reference audio data and the received audio data.

7. The system of claim 1, wherein execution of the instructions further causes the system to:
compare the score with a threshold, the threshold indicative of the alert sound being sufficiently perceptible to the occupant such that the occupant perceives the alert sound as the warning; and
determine the score does not satisfy the threshold to indicate that the occupant did not perceive the alert sound as the warning.

8. A method for alert detection in a vehicle, comprising:
triggering a start of a time window in which an alert sound is expected to be perceived by an occupant of the vehicle as a warning to the occupant;
generating a signal to output the alert sound in the vehicle and in the time window;
receiving audio data representing a plurality of acoustic sounds present in the vehicle and in the time window;
determining, using the received audio data, a score representing a likelihood the occupant perceived the alert sound as the warning; and
generating an alert to gain attention of the occupant when the score indicates the occupant did not perceive the alert sound as the warning.

9. The method of claim 8, wherein generating the alert comprises displaying a graphic on a graphical user interface in the vehicle.

10. The method of claim 8, wherein the alert sound is a first alert sound, and generating the alert comprises outputting a second alert sound of a different type than the first alert sound.

11. The method of claim 8, wherein generating the alert comprises providing haptic feedback to the occupant.

12. The method of claim 11, wherein providing haptic feedback to the occupant comprises vibrating, in the vehicle, at least one of a steering wheel or one or more vehicle seats.

13. The method of claim 8, wherein determining the score comprises:
obtaining reference audio data representative of a recording of the alert sound;
comparing the reference audio data and the received audio data for similarity; and
determining the score based on the similarity of the reference audio data and the received audio data.

14. The method of claim 8, further comprising:
comparing the score with a threshold, the threshold indicative of the alert sound being sufficiently perceptible to the occupant such that the occupant perceives the alert sound as the warning; and
determining the score does not satisfy the threshold to indicate that the occupant did not perceive the alert sound as the warning.

15. A vehicle comprising:
at least one audio output device to output an alert sound;
at least one audio sensor to receive a plurality of acoustic sounds present in the vehicle;
an alert detection system;
at least one storage medium storing processor-executable instructions; and
at least one processor communicatively coupled to the at least one storage medium and, when the at least one processor executes the processor-executable instructions, causes the vehicle to:
trigger, by the alert detection system, a start of a time window in which the alert sound is expected to be output from the at least one audio output device and perceived by the occupant as a warning to the occupant;
generate, by the alert detection system, a signal to output the alert sound from the at least one audio output device and in the time window;
receive, by the alert detection system, audio data representing the plurality of acoustic sounds received via the at least one audio sensor;
determine, by the alert detection system and using the received audio data, a score representing a likelihood the occupant perceived the alert sound as the warning; and
generate an alert to gain attention of the occupant when the score indicates the occupant did not perceive the alert sound as the warning.

16. The vehicle of claim 15, further comprising at least one display device, and wherein execution of the instructions further causes the vehicle to generate the alert by displaying a graphic on a graphical user interface on at least one of the at least one display device.

17. The vehicle of claim 15, wherein the alert sound is a first alert sound, execution of the instructions further causes the vehicle to generate the alert by outputting a second alert sound using the at least one audio output device, and the second alert sound of a different type than the first alert sound.

18. The vehicle of claim 15, further comprising a steering wheel, and wherein execution of the instructions further causes the vehicle to generate the alert by providing haptic feedback to the occupant through vibration of the steering wheel.

19. The vehicle of claim 15, further comprising a vehicle seat, and wherein execution of the instructions further causes the vehicle to provide haptic feedback to the occupant through vibration of the vehicle seat.

20. The vehicle of claim 15, wherein execution of the instructions further causes the vehicle to determine the score by:
obtaining reference audio data representative of a recording of the alert sound;
comparing the reference audio data and the received audio data for similarity; and
determining the score based on the similarity of the reference audio data and the received audio data.
